(19) United States
(12) Patent Application Publication
(10) Pub. No.: US 2012/0024433 A1
(43) Pub. Date: Feb. 2, 2012

(54) MULTI-ALLOY ASSEMBLY HAVING CORROSION RESISTANCE AND METHOD OF MAKING THE SAME

(75) Inventors: Cagatay Yanar, Bethel Park, PA (US); James P. Moran, North Huntington, PA (US); Harry R. Zonker, Pittsburgh, PA (US); Ralph R. Sawtell, Gibsonia, PA (US)

(73) Assignee: Alcoa Inc., Pittsburgh, PA (US)

(21) Appl. No.: 13/193,053

(22) Filed: Jul. 28, 2011

Related U.S. Application Data
(60) Provisional application No. 61/369,563, filed on Jul. 30, 2010.

(51) Int. Cl. B32B 15/01; B32B 7/08; B32B 15/20; C22F 1/04; B23K 28/00

(52) U.S. Cl. 148/535; 148/416; 428/583

(57) ABSTRACT

An assembly and method of making the assembly are provided. The assembly includes: a first 7xxx series aluminum alloy member comprising not greater than 1 wt. % Cu; a second 7xxx series aluminum alloy member comprising at least 1 wt % Cu; a joint between the first member and the second member that joins the first member to the second member; wherein the assembly comprises a stress corrosion cracking resistance for a marine environment.

### CROSS-REFERENCE TO RELATED APPLICATION

This patent application claims priority to U.S. Provisional Patent Application No. 61/369,563 filed Jul. 30, 2010; which is incorporated herein by reference in its entirety.

### BACKGROUND

When in a marine environment, certain aluminum products with 7XXX aluminum alloy(s) experience low stress corrosion cracking thresholds when loaded in certain directions and/or at locations with joints (e.g. welds).

### SUMMARY OF THE DISCLOSURE

Broadly, the present disclosure relates to an assembly having a high copper 7xxx series aluminum alloy member joined to a low copper 7xxx series aluminum alloy member. The corrosion properties of the assembly are tailored to facilitate corrosion resistance (e.g. stress corrosion cracking resistance) in harsh environments. Thus, assemblies of the instant disclosure may realize a long service life, have multi-dimensional load bearing capabilities (e.g. load in the ST, L and LT directions), and remain durable, even after prolonged exposure to corrosive environments, such as salt water. For example, the assemblies (sometimes called “pipe assemblies”) are employable in marine applications where three-dimensional loading stresses are encountered, e.g., while the assembly is submerged in a marine environment. The marine applications may be salt water applications, or fresh water applications (e.g. having corrosive ions and/or materials), at varying depths, water temperatures, and/or other various conditions. Some examples of marine applications include drilling, dredging, constructing load-bearing structures, and/or marine aggregate placing equipment.

One aspect of the instant disclosure provides an assembly including: a first 7xxx series aluminum alloy member comprising not greater than 1 wt. % Cu; a second 7xxx series aluminum alloy member comprising at least 1 wt % Cu; a joint between the first member and the second member that joins the first member to the second member; wherein the assembly exhibits a stress corrosion cracking resistance for a marine environment.

Stress corrosion cracking (SCC) as used herein, means the failure of an object under stress, by cracking/exhibiting cracks. In some embodiments, SCC results from multi-dimensional loading under prolonged stress conditions. Thus, in some embodiments, SCC resistance includes resistance to SCC at one or more directions of loading, including, ST, L, and/or LT directions at a certain stress load/threshold (MPa).

A marine environment refers to water having a salt content (e.g. salinity). For example, a marine environment includes saltwater or water having a measureable salinity. In some embodiments, a marine environment is simulated through various tests, including for example ASTM tests.

In one embodiment, the first member passes stress corrosion cracking resistance tests at a stress level of 213 MPa, as measured in accordance with the boiling salt water test, ASTM standard G-103, in the L direction for a period of at least 7 days.

In one embodiment, the first member shows no pitting corrosion or intergranular corrosion in accordance with the type of attack test, ASTM G-110.

In one embodiment, the second member passes stress corrosion cracking resistance tests at a stress level of 240 MPa, as measured in accordance with the alternate immersion test, ASTM standards G-44, G-47, and G-49, in the ST direction for a period of at least 30 days. In some embodiments, the second member passes SCC resistance tests when loaded in an ST, LT, and/or L direction.

In some embodiments, the second member of the assembly comprises a corrosion potential that is at least 5 mV less than the low copper zone of the joint.

In some embodiments, the second member comprises an overaged temper.

In some embodiments, the joint is a weld. In some embodiments, the joint is a solid state weld. In some embodiments, the joint is a friction stir weld. In some embodiments, the joint comprises a tensile yield strength of at least about 297 MPa, as measured across the joint.

In another aspect of the instant disclosure, an assembly is provided. The assembly includes: a first member comprising a 7xxx series aluminum alloy having not greater than 1 wt. % Cu; a second member comprising a 7xxx series aluminum alloy member having at least 1 wt % Cu, wherein the second member comprises an overaged condition; and a weld attaching the first member and the second member, wherein the weld includes a low Cu zone; wherein the low Cu zone of the weld comprises a stress corrosion cracking resistance in a marine environment due to the overaged condition.

In one embodiment, the low Cu zone of the weld comprises a corrosion potential of at least 5 mV above a corrosion potential of the second member, as measured in accordance with ASTM G-69.

In one embodiment, the stress corrosion cracking resistance in the marine environment includes the low Cu zone of the weld passes stress corrosion cracking resistance tests at a stress level of 170 MPa as measured in accordance with the boiling salt test, ASTM standard G-103 across the weld for a period of at least 6 days.

In one embodiment, the first member is an extrusion. In one embodiment, the second member is selected from an extrusion and a forging. In one embodiment, the overaged condition of the second member comprises a T7 temper.

In another aspect of the instant disclosure, a method of making an assembly is provided: The method includes: (a) welding a first member comprising: a 7xxx series aluminum alloy having not less than 1 wt. % Cu to a second member comprising a 7xxx series aluminum alloy member having not greater than 1 wt. % Cu, thereby producing an assembly having a weld, the weld including a low Cu zone and a high Cu zone; and (b) thermally treating the assembly at a sufficient time and temperature such that the second member comprises an overaged temper; wherein due to the thermally treating step, the low Cu zone of the weld comprises an improved stress corrosion cracking resistance in a marine environment. In some embodiments, the thermally treating step includes thermally treating at least one of the second member and the low Cu zone of the weld such that there exists a difference in corrosion potential of at least about 5 mV between the second member and the low Cu zone of the weld.

In one embodiment, the thermally treating step comprises aging the second member to a T7 temper. In one embodiment, the due to the thermally treating step, the second member comprises a corrosion potential difference at least about 5 mV lower than the low Cu zone of the weld. In some embodiments, the aging step is completed on a mechanical joint. In some embodiments, the aging step is completed on a weld (e.g. post weld aging). In one embodiment, the method comprises increasing at least one of the time or temperature of the thermally treating step to increase the corrosion potential difference between the low Cu weld zone and the second member (e.g. pipe assembly).

In one embodiment, the welding comprises friction stir welding.

As referred throughout, the “a first member comprising: a 7xxx series aluminum alloy having not less than 1 wt. % Cu” is sometimes referred to as a “high Cu member”. As referred throughout, the “a second member comprising a 7xxx series aluminum alloy member having not greater than 1 wt. % Cu” is sometimes referred to as a “low Cu member”.

Referring to FIG. 1, an assembly 10 is depicted (e.g. pipe assembly). The assembly 10 includes a high copper member 12 (e.g. a coupling member 20), a low copper member 14 (e.g. a pipe 22), and a joint 16 (e.g. depicted as a weld zone 18). The weld zone 18 depicted is a friction stir weld. In one embodiment, the high copper aluminum alloy member has a stress corrosion cracking resistance (SCC resistance) sufficient for load-bearing in a multi-dimensional manner (e.g. ST, SL and L directions) for extended periods of time and/or at various stress loads (measured in MPa), while the low copper aluminum alloy member has a good general corrosion resistance and/or good pitting resistance (defined below). The low copper zone of the weld also includes a good SCC resistance. Thus, in some embodiments, the different members of the assembly may have increased corrosion resistance to different types of corrosion, including stress corrosion, general corrosion and/or pitting corrosion.

Corrosion, as defined, by ASTM G5 means a chemical or electrochemical reaction between a material, usually a metal, and its environment that produces a deterioration of the material and its properties. Corrosion includes general corrosion, mass loss, exfoliation, and stress corrosion. Corrosion resistance, as used herein, means an object's ability to withstand corrosion, or undergo a limited amount of corrosion, under certain conditions. When measured, corrosion can be quantified as general corrosion, pitting corrosion, and intergranular corrosion.

Ultimate tensile strength (hereinafter referred to as UTS) means the maximum stress that a material is capable of sustaining in tension under a gradual and uniformly applied load.

Tensile yield strength (hereinafter referred to as TYS) is determined from an amount of stress to achieve a given amount of permanent plastic deformation. Usually, the TYS is the value of stress at the onset of deformation in an object.

Elongation, as used herein, refers to a measure of ductility or the ability of a material to deform plastically under tensile loading without fracture. In one embodiment, total elongation is measured in a tensile test, and refers to the measure of ductility in the object undergoing elongation stresses. UTS, TYS, and elongation are tested in accordance with ASTM E8, and B557.

General corrosion, as used herein, refers to how quickly material is dissolved from the surface of an object. In one embodiment, general corrosion is tested in accordance with ASTM G59, which is the standard test method for conducting potentiodynamic polarization resistance measurements, with the exception to ASTM G59 that the test environment is a quiescent (i.e., open to the air, with no aeration or deaeration) solution of 3.5% NaCl. In one embodiment, a low copper member (e.g. low copper 7xxx aluminum alloys) realizes a corrosion current density (i_{corr}) of not greater than about 5×10⁻⁵ amperes per square centimeter. In other embodiments, a low copper member may realize a corrosion current density (i_{corr}) of not greater than about 4×10⁻⁵ amperes per square centimeter, or not greater than about 3×10⁻⁵ amperes per square centimeter, or not greater than about 2×10⁻⁵ amperes per square centimeter, or not greater than about 1×10⁻⁵ amperes per square centimeter, or less.

The Alternate Immersion Test, ASTM G-47 (ref. ASTM-G44), is a standard test method for evaluating the stress corrosion cracking resistance of aluminum alloys by alternate immersion in 3.5% NaCl (e.g. high Cu aluminum alloys and/or high strength 7xxx aluminum alloy wrought products. This method utilizes a one hour cycle; 10 minutes immersed in 3.5% NaCl and 50 minutes out of solution in a controlled temperature and humidity atmosphere. This one hour cycle is repeated 24 hours per day for extended exposure periods (e.g. 20-90 days), depending on the relative susceptibility of the material being tested and the intended service environment. Specimens are generally stressed to a specified percentage of the material yield strength or to pertinent stress(es) for the service application. Unstressed specimens can also be exposed in this environment to evaluate the impact of the applied stress. Results are generally reported as pass/fail but when no failures occur and breaking load tests are often conducted after the exposure to determine the residual strength of the exposed material.

The Boiling Salt Test, ASTM G103 is a standard test method for evaluating the stress corrosion cracking (SCC) resistance of low copper Al—Zn—Mg alloys (e.g. 7xxx type alloys with less than 0.25% Cu). Effects of composition, magnitude of applied stress, thermo-mechanical processing and other fabrication variables on the relative SCC resistance can be compared. The relative SCC resistance of low Cu Al—Zn—Mg alloys correlates better with performance in the boiling salt test than other accelerated corrosion/SCC tests (e.g. ASTM G44).

The “Modified Alternate Immersion in Simulated Seawater Environment” Test is a modification of the Alternate Immersion Test (ASTM G47/ASTM G44) designed specifically for evaluating the stress corrosion cracking resistance of aluminum alloys that are subjected to full immersion in sea-water. Specimens are stressed according to the ASTM G47. This method utilizes a one week cycle; 160 hours full, constant, immersion in ASTM D-1141 artificial “Sea Salt”, and 8 hours of alternate immersion, cycling according to ASTM G44 (10 minutes immersed in ASTM D-1141 artificial “Sea Salt” and 50 minutes out of solution in a controlled temperature and humidity atmosphere). This weekly cycle is repeated continuously for extended periods of time depending on exposure conditions of the intended service environment. Results are reported as pass/fail. Breaking load tests may be conducted after the exposure to determine the residual strength passing specimens.

In one embodiment, a high copper member (high copper 7xxx alloys) realizes a corrosion current density of not greater than about 50×10⁻⁶ amperes per square centimeter. In other embodiments, a high copper member realizes a corrosion current density of not greater than about 40×10⁻⁶ amperes per square centimeter, or of not greater than about 30×10⁻⁶ amperes per square centimeter, or not greater than about 20×10⁻⁶ amperes per square centimeter, or of not greater than about 10×10⁻⁶ amperes per square centimeter, or less.

Pitting, as used herein, means localized corrosion (or non-uniform electro-deposition) which may appear as cavities in a surface. In one embodiment, pitting is measured in accordance with ASTM G110, which is the standard practice for evaluating intergranular corrosion resistance of heat treatable aluminum alloys by immersion in sodium chloride and hydrogen peroxide solution (e.g. average maximum pit depth measurement). In one embodiment, the low copper member has an average maximum pit depth of less than about 20 microns. In some embodiments, the low copper member has an average maximum pit depth of less than about: 15 microns; 10 microns, 5 microns, 3 microns, 1 micron, 0.5 micron, 0.1 micron, 0.001 micron, or 0 microns (no pitting). In one embodiment, the high copper member has an average maximum pit depth of less than about 500 microns. In some embodiments, the high copper member has an average maximum pit depth of not greater than about: 400 microns, 300 microns, 250 microns, 200 microns, 150 microns, 100 microns, 80 microns, 60 microns, 50 microns, 40 microns, 30 microns, or 20 microns. In one embodiment for the high copper member, the average maximum pit depth is about 100 microns to about 300 microns. In another embodiment, the average max pit depth is: about 10 microns, about 20 microns, about 30 microns, about 40 microns, about 50 microns, about 70 microns, or about 100 microns for the high copper member.

In another embodiment, pitting resistance is measured by determining the pitting density across the alloy's surface, for example x pits/mm², where x is the number of pits. In this embodiment, pitting density is tested in accordance with ASTM G46.

In one embodiment, the low copper aluminum alloy member has high general corrosion resistance and pitting resistance, while the high copper aluminum alloy member has high stress corrosion resistance, and is load-bearing in a multi-dimensional manner for large loads at extended periods of time. In an assembly, the low copper member may take the form of a component that is resistant to pitting, while the high copper member may take the form of a component in the assembly that is resistant to SCC.

High copper member, as used herein, refers to a 7xxx series aluminum alloy having at least about 1 wt. % copper. In some embodiments, high copper is present in an amount of at least about 1%; of at least about 1.5%, of at least about 2%, of at least about 2.5%, of at least about 3%, of at least about 3.5%. Suitable examples of high copper alloys include: Aluminum Association alloys 7049; 7150; 7075; 7085 and 7185, among others. Compositional limits of some non-limiting examples of high copper alloys are listed in a table at the end of the Examples section. In some embodiments, copper is present in an amount ranging from about 1 wt. % to about 3.5 wt. %.

Stress corrosion as used herein, means the corrosion in a material which is due to the material being under loading (e.g. multi-dimensional loading), high load, prolonged load and/or other physical stresses. In one embodiment, the high copper member is an overaged temper. As used herein, overaged refers to applying a thermal treatment to a material which produces a strength beyond a point of maximum strength to provide control of some significant characteristic. In one embodiment, the high copper member is in a T7 temper, as defined by the Aluminum Association, as embodied in ANSI H35.1. The T7 temper may be any of: a T73, a T74, a T76, a T79, or a T77 temper, among others.

In one embodiment, stress corrosion cracking resistance is measured by alternate immersion testing in the high copper members in accordance with ASTM G47 and G44. In some embodiments, the high Cu member (second member) has an SCC resistance of: at least about 50 MPa; at least about 60 MPa; at least about 69 MPa; at least about 80 MPa; at least about 90 MPa; at least about 103 MPa; at least about 110 MPa; at least about 120 MPa; at least about 130 MPa; at least about 138 MPa; at least about 150 MPa; at least about 165 MPa; at least about 172 MPa; at least about 180 MPa; at least about 190 MPa; at least about 200 MPa; at least about 207 MPa; at least about 234 MPa, at least about 241 MPa; at least about 250 MPa; or at least about 260 MPa when measured in the alternate immersion in accordance with ASTM G-44, for a period of time. In some embodiments, the period of time includes: 10 days; 20 days; 50 days; 70 days; 100 days; 200 days; 300 days; a year; 500 days; two years; and the like.

In some embodiments, the low copper member refers to a 7xxx series aluminum alloy having at least about 0.2 wt. % less copper than the high copper member (i.e., HCM-Cu minus LCM-Cu ≧0.2 wt. %). As an example, if the high copper member includes about 1 wt. % Cu, the low copper member includes not greater than about 0.8 wt. % copper. In some embodiments, the low copper member includes at least about 0.3 wt. %; 0.4 wt. %; 0.5 wt. %; 0.6 wt. %; 0.7 wt. %; or 0.8 wt % less copper than the high copper member. In other embodiments, the low copper member includes at least about 1 wt. %; 1.5 wt. %; 2 wt. %; 2.5 wt. %; 3 wt. %; or 3.5 wt % less copper than the high copper member.

In some embodiments the low copper member may include less than about 1 wt. % copper, such as less than 0.9 wt. % Cu; less than about 0.8 wt. % Cu; less than about 0.7 wt. % Cu; less than about 0.6 wt. % Cu; less than about 0.5 wt. % Cu; less than about 0.4 wt. % Cu; less than about 0.3 wt. % Cu; less than about 0.2 wt. % Cu; less than about 0.1 wt. % Cu; or less than about 0.05 wt. % Cu; or no Cu. Suitable examples of low copper (or no copper) 7xxx series aluminum alloys include: Russian alloy standard OST 5R.9466-88 (see Appendix A); Russian alloy standard OST 1 92014-90; and/or Aluminum Association alloys 7003; 7004; 7005; 7017; 7018; 7019; 7022; 7030; and 7039, among others. Compositional limits of some non-limiting examples are in the Table on the end of the Examples section.

In some embodiments, the 7xxx series aluminum alloys include Mg in an amount of at least about 0.5 wt. %. In some embodiments, Mg is present in an amount not greater than about 3.5%.

In some embodiments, the assembly (e.g. pipe assembly) includes a mechanical joint/mechanical connection between the low copper member (e.g. pipe) and the high copper member (e.g. coupling member). Suitable examples of the joint, without being limited to any of the following, include: a threaded engagement (male and female); a sleeve and tapered portion; a pair of mechanically fastened collars; bolted attachments, or other types of mechanical connections or joints.

Joining the high copper member to the low copper member is done through one or more techniques. Joining as used herein, refers to one or more of: connecting, attaching, welding, mechanically fastening, adhering, among others, and combinations thereof, in order to join one member to another member. The joining step results in a joint between the high copper member and the low copper member.

Referring to FIG. 2, one embodiment of an assembly 10 (e.g. pipe assembly) is depicted. In this embodiment, the assembly 10 (e.g. pipe assembly) includes a high copper member 12 (as a coupling member 14), a low copper member as a pipe 22, and a joint 16 which connects the pipe 22 to the coupling member 20. As shown, the joint 16 is a threaded attachment (e.g. mechanical connection) having corresponding threads on the interior of the high copper coupling member which fit to threads of the exterior of the low copper member pipe 22.

In some embodiments, the joint includes a weld (see, e.g. FIG. 1). Welding, as used herein, means a process used to join metals together by the application of heat, pressure, and combinations thereof. Non-limiting examples of welding include: friction stir welding; fusion welding; pressure welding; gas welding; arc welding; resistance welding; inertia welding; cold welding; among others; and combinations thereof. In some embodiments, the weld is a solid state weld. As used herein, solid state welding refers a welding process in which the weld is produced without the addition of a filler metal (e.g. brazing filler metal) at temperatures below the melting point of the base metals being joined (with or without pressure). Some non-limiting examples of solid state welding include: friction welding, inertia welding, friction stir welding, and the like. Friction stir welding means a solid state of welding used to join aluminum alloys. Friction stir welding is used to join high strength 7xxx alloys which are generally not fusion weldable. In fusion welding, which includes gas, arc, and resistance welding, the parent metal is melted. In pressure welding, joining is accomplished by the use of heat and pressure without melting. The parts are pressed together and heated simultaneously, so that a metallurgical bond is created across the interface. In some embodiments, the weld is a mixture of the two parent metals. In some embodiments, the weld is a partial mixture of the two parent metals, for example, with a low Cu zone and a high Cu zone.

In some embodiments, the weld strength has a tensile yield strength of: at least about 50 MPa; at least about 60 MPa; at least about 69 MPa; at least about 80 MPa; at least about 90 MPa; at least about 103 MPa; at least about 110 MPa; at least about 120 MPa; at least about 130 MPa; at least about 138 MPa; at least about 150 MPa; at least about 160 MPa; at least about 172 MPa; at least about 180 MPa; at least about 190 MPa; at least about 200 MPa; at least about 207 MPa; at least about 220 MPa; at least about 230 MPa; at least about 241 MPa; at least about 250 MPa; at least about 260 MPa; at least about 270 MPa; at least about 276 MPa; at least about 280 MPa; at least about 290 MPa; at least about 300 MPa; at least about 310 MPa; at least about 320 MPa; at least about 330 MPa; at least about 345 MPa; at least about 350 MPa; at least about 360 MPa; at least about 370 MPa; at least about 379 MPa, at least about 390 MPa; or at least about 400 MPa.

In some embodiments, the low Cu zone of the weld has an SCC resistance of: at least about 50 MPa; at least about 69 MPa; at least about 80 MPa; at least about 90 MPa; at least about 103 MPa; at least about 110 MPa; at least about 120 MPa; at least about 130 MPa; at least about 138 MPa; at least about 150 MPa; at least about 160 MPa; at least about 172 MPa; at least about 180 MPa; at least about 190 MPa; at least about 200 MPa; at least about 207 MPa; at least about 220 MPa; at least about 230 MPa; at least about 241 MPa; at least about 250 MPa; at least about 260 MPa; at least about 270 MPa; at least about 276 MPa; at least about 280 MPa; at least about 290 MPa; at least about 300 MPa; at least about 310 MPa; at least about 320 MPa; at least about 330 MPa; at least about 345 MPa; at least about 350 MPa; at least about 360 MPa; at least about 370 MPa; at least about 379 MPa; at least about 390 MPa; or at least about 400 MPa when measured in accordance with ASTM G103 for a period of time. In some embodiments, the period of time includes 1 day, 3 days, 5 days, 7 days, 10 days, 12 days, or 14 days. (To convert MPa to ksi, multiply by 0.1450377.)

In some embodiments, the weld has an SCC resistance of: at least about 50 MPa; at least about 60 MPa; at least about 69 MPa; at least about 80 MPa; at least about 90 MPa; at least about 103 MPa; at least about 110 MPa; at least about 120 MPa; at least about 130 MPa; at least about 138 MPa; at least about 150 MPa; at least about 160 MPa; at least about 172 MPa; at least about 180 MPa; at least about 190 MPa; at least about 200 MPa; at least about 207 MPa; at least about 220 MPa; at least about 230 MPa; at least about 241 MPa; at least about 250 MPa; at least about 260 MPa; at least about 270 MPa; at least about 276 MPa; at least about 280 MPa; at least about 290 MPa; at least about 300 MPa; at least about 310 MPa; at least about 345 MPa; at least about 350 MPa; at least about 360 MPa; at least about 370 MPa; at least about 379 MPa; at least about 390 MPa; or at least about 400 MPa when measured in accordance with ASTM G44 for a period of time. In some embodiments, the period of time includes: 1 day; 5 days; 7 days; 10 days; 20 days; 50 days; 70 days; 100 days; 200 days; 300 days; a year; 500 days; two years; and the like.

In some embodiments, the weld has an SCC resistance of: at least about 50 MPa; at least about 60 MPa; at least about 69 MPa; at least about 80 MPa; at least about 90 MPa; at least about 103 MPa; at least about 110 MPa; at least about 120 MPa; at least about 130 MPa; at least about 138 MPa; at least about 150 MPa; at least about 160 MPa; at least about 172 MPa; at least about 180 MPa; at least about 190 MPa; at least about 200 MPa; at least about 207 MPa; at least about 220 MPa; at least about 230 MPa; at least about 241 MPa; at least about 250 MPa; at least about 260 MPa; at least about 270 MPa; at least about 276 MPa; at least about 280 MPa; at least about 290 MPa; at least about 300 MPa; at least about 310 MPa; at least about 345 MPa; at least about 350 MPa; at least about 360 MPa; at least about 370 MPa; at least about 379 MPa; at least about 390 MPa; or at least about 400 MPa when measured in the constant immersion (modified alternate immersion test) for a period of time. In some embodiments, the period of time includes: 1 day; 5 days; 7 days; 10 days; 20 days; 50 days; 70 days; 100 days; 200 days; 300 days; a year; 500 days; two years; and the like.

In some embodiments, the second member (e.g. high copper coupling member) includes a locking mechanism. The locking mechanism refers to the part of the coupling member which allows two or more pipes to be removably connectable (e.g. axially aligned and secured together). In some embodiments, the locking mechanism maintains secure, load-bearing configuration of a series of assemblies (e.g. pipe assemblies), attached to the end. In one embodiment, the locking mechanisms are different shapes, with alternating indentations/protrusions that fit together (e.g. mirror images).

In some embodiments, the low Cu and/or high Cu 7xxx members are generally produced as a casting product (e.g., a foundry product) or a wrought product. For example, the low Cu member may be an extrusion (e.g. a pipe). The high Cu member may be a forging. In some embodiments, the members are cast, forged, sheet, plate, or combinations thereof. In either case, conventional wrought processes may be employed to produce the members. In one embodiment, the process includes casting, scalping, homogenization, solution heat treatment and quenching of a member. After quenching, a member (or a portion thereof) may be artificially aged (sometimes referred to herein as “thermally treated”) to achieve the desired temper, such as any of the T7 tempers described above. Various techniques and processes of thermally treating 7xxx aluminum alloys, as well as compositions useful in making suitable high Cu 7xxx aluminum alloys, are disclosed in U.S. Pat. No. 6,972,110, which is incorporated by reference herein in its entirety. In some embodiments, thermally treating is completed by localized heating of only certain areas of the pipe assembly, for example, by blanket heat treatment. In other embodiments, the entire pipe is thermally treated by putting the pipe into a furnace. Thermally treating may include one, two or more individual heating steps, and may also include cooling steps. In some embodiments, cooling is done at ambient temperatures (e.g. room temperature), or cooling is completed with blowers, air or liquid quenching and the like, as desired. The thermal treatment may include heating at least a portion of the assembly to an elevated temperature for a period of time.

In one embodiment, the assembly (e.g. aluminum product) is made through the process steps of by casting, homogenizing, hot working (e.g. rolling, extruding, forging), aging (e.g. solution heat treating), quenching, cold working, aging, welding, and aging. In one embodiment, the assembly (e.g. aluminum product) is made by casting, homogenizing, hot working (e.g. rolling, extruding, forging), aging (e.g. solution heat treating), quenching, welding, and aging. In one embodiment, the assembly (e.g. aluminum product) is made by casting, homogenizing, hot working (e.g. rolling, extruding, forging), aging (e.g. solution heat treating), quenching, cold working, aging, welding, and aging.

In some embodiments, the thermally treating step is done to one or more assembly components, including the low copper member, the high copper member, the weld zone, and combinations thereof. The weld zone means the area where the high copper member is attached or joined to the low copper member. The weld zone includes a distal portion and a proximal portion. The distal portion refers to the portion of the weld zone which is adjacent to the low copper member, while the proximal portion refers to the portion of the weld zone which is adjacent to the high copper member. In some embodiments, the weld zone includes the site of fusion of the two materials. In some embodiments, the weld zone includes the heat-affected zone on either side of the site of fusion.

In one embodiment, at least one of the assembly, the high Cu member, the low Cu member, and the weld are thermally treated. Thermally treating is an example of aging. In one embodiment, aging is completed to age the assembly, or portions thereof, to a temper sufficient to impart stress corrosion cracking resistance on the assembly (e.g. at the low Cu zone of the weld). In some embodiments, aging includes aging to a sufficient time or temperature to impart an averaged temper in the high copper member. Aging may include aging at about 315 F for at least about 18 hrs, or a substantially equivalent aging temperature and duration. As appreciated by those skilled in the art, aging temperatures and/or times may be adjusted based on well known aging principles and/or formulas. Thus, those skilled in the art could increase the aging temperature but decrease the aging time, or vice-versa, or only slightly change only one of these parameters, and still achieve the same result as “aging to a temper sufficient to impart stress corrosion cracking resistance on the assembly (e.g. the low Cu zone of the weld). The amount of artificial aging practices that could achieve the same result as is numerous, and therefore all such substitute aging practices are not listed herein, even though they are within the scope of the present invention. The use of the phrase “or a substantially equivalent artificial aging temperature and duration” or the phrase “or a substantially equivalent practice” is used to capture all such substitute aging practices. As may be appreciated, these substitute artificial aging steps can occur in one or multiple steps, and at one or multiple temperatures. Several discrete examples of time and temperature combinations are set forth in the Examples section. Some non-limiting examples of aging temperatures used in aging practice include: aging at temperatures of at least about 250 F; at least about 260 F; at least about 270 F; at least about 280 F; at least about 290 F; at least about 300 F; at least about 310 F; at least about 320 F; at least about 330 F; at least about 340 F; at least about 350 F; at least about 360 F; at least about 380 F; at least about 390 F; or at least about 400 F. Some non-limiting examples of aging practice include: aging at temperatures of not greater than about 250 F; not greater than about 260 F; not greater than about 270 F; not greater than about 280 F; not greater than about 290 F; not greater than about 300 F; not greater than about 310 F; not greater than about 320 F; not greater than about 330 F; not greater than about 340 F; not greater than about 350 F; not greater than about 360 F; not greater than about 380 F; not greater than about 390 F; or not greater than about 400 F. Some non-limiting examples of aging times used in aging practices include: at least about 1 hr; at least about 2 hrs; at least about 4 hrs; at least about 8 hrs; at least about 10 hrs; at least about 15 hrs; at least about 18 hrs; at least about 20 hrs; at least about 22 hrs; at least about 25 hrs; at least about 30 hrs; at least about 32 hrs; at least about 35 hrs; at least about 40 hrs; at least about 45 hrs; at least about 50 hrs; at least about 5 hrs; at least about 60 hrs; at least about 65 hrs; at least about 70 hrs; at least about 75 hrs; at least about 80 hrs; at least about 100 hrs; at least about 120 hrs; at least about 140 hrs; at least about 160 hrs; at least about 180 hrs; or at least about 200 hrs. Some non-limiting examples of aging times used in aging practices include: not greater than about 1 hr; not greater than about 2 hrs; not greater than about 4 hrs; not greater than about 8 hrs; not greater than about 10 hrs; not greater than about 15 hrs; not greater than about 18 hrs; not greater than about 20 hrs; not greater than about 22 hrs; not greater than about 25 hrs; not greater than about 30 hrs; not greater than about 32 hrs; not greater than about 35 hrs; not greater than about 40 hrs; not greater than about 45 hrs; not greater than about 50 hrs; not greater than about 5 hrs; not greater than about 60 hrs; not greater than about 65 hrs; not greater than about 70 hrs; not greater than about 75 hrs; not greater than about 80 hrs; not greater than about 100 hrs; not greater than about 120 hrs; not greater than about 140 hrs; not greater than about 160 hrs; not greater than about 180 hrs; or not greater than about 200 hrs.

In some embodiments, after the thermally treating step, there exists an electrochemical potential difference (e.g. corrosion potential difference) between the high copper alloy and the low copper portion of the weld zone (and/or low copper member). Electrochemical potential difference, as used herein, means a difference in the potential of one alloy to another alloy, due to the different properties of the alloys. Without being bound to a particular mechanism or theory, in some embodiments, when two alloys are welded together, one alloy will act as the anode, while the other will act as the cathode. In some embodiments of the assembly, the corrosion potential difference is generated with the thermally treating step and the electrochemical potential contributes to the sacrificial protection of the low copper weld zone by the high copper member. In one embodiment, after the thermally treating step, the weld zone has a SCC resistance of at least about 34 MPa.

In some embodiments, the corrosion potential difference (e.g. between components of the assembly, including the high copper member and the weld zone/low copper portion of the weld zone) is: at least about 1 mV; at least about 2 mV; at least about 5 mV; at least about 10 mV; at least about 15; at least about 20 mV, such as: at least about 30 mV; or at least about 40 mV; or at least about 50 mV; or at least about 60 mV; or at least about 70 mV; or at least about 80 mV; or at least about 90 mV; or at least about 100 mV; or at least about 120 mV; or at least about 130 mV; or at least about 140 mV; or at least about 150 mV; or higher. In one embodiment, the weld zone of the low copper member is at least about 20 mV more electronegative (e.g. higher corrosion potential) than the high copper member. In one embodiment, the corrosion potential of the high copper member is at least about 5 mV lower than the corrosion potential of the low copper member of the weld zone. In some embodiments, the corrosion potential is the average value across a section (or portion of a section). In some embodiments, the corrosion potential includes discrete values (e.g. mean value or value at a particular location on the assembly or member).

Referring to FIG. 3, an assembly 10 which includes a weld (e.g. friction stir weld zone) 18 is depicted. The assembly 10 includes a low copper member 14, a high copper member 12, and a weld zone 18. Also depicted are Zones B and E which are heat affected zones. Zone C is the proximal portion 26 of the weld zone 18 which is adjacent to the high copper member 12. Zone D depicts the distal portion 28 of the weld zone 18 which is adjacent to the low copper member 14. FIG. 4 depicts the potential versus SCE measured in volts with respect to the distance from the center weld line of the friction stir weld zone of FIG. 3. Also depicted are four different thermally treating steps, including post weld aging step 1, post weld aging step 2, post weld aging step 3 and post weld aging step 4. As shown in FIG. 4, as the distance from the weld center line increases, the change in electrochemical potential also changes.

In some embodiments, the assemblies and or methods of making the assemblies include at least one of: coating one or more assembly components with an anodized layer; incorporating an organic barrier to at least a portion of the assembly; incorporating one or more sacrificial nodes into one or more assembly components; and combinations thereof.

One aspect of the invention provides: a method including joining a high copper 7xxx series aluminum alloy member to a low copper 7xxx series aluminum alloy member, thereby producing an assembly, wherein the high copper member includes not less than about 1 wt. % copper, is in a T7 temper, and achieves a SCC corrosion resistant of at least about 103 MPa when tested in accordance with G44 and G47; wherein the low copper member comprises at least 0.2 wt. % less than high copper member; wherein the low copper member achieves a corrosion current of less than about 1×10⁻⁶ amps/cm² when measured in accordance with ASTM G5.

Another aspect of the instant disclosure provides an assembly. The assembly includes: a low copper 7xxx series aluminum alloy member; wherein the low copper member comprises: at least 0.2 wt. % less than high copper member; wherein the low copper member comprises less than about 1 wt. % copper; and wherein the low copper member achieves a pit depth of not exceeding about 5 microns when tested in accordance with ASTM G110; a high copper 7xxx series aluminum alloy; wherein the high copper member includes: not less than about 1% wt, % copper, is in a T7 temper, and achieves a SCC corrosion resistant of at least about 103 MPa when tested in accordance with G44 and G47; and a joint, which joins the high copper member to the low copper member.

In yet another aspect of the present invention, a method is provided. The method includes welding a high Cu 7xxx series aluminum alloy coupling member to a 7xxx series aluminum alloy pipe, thereby producing a pipe assembly having a weld zone, the weld zone comprising: a proximal portion; and a distal portion; wherein the proximal portion is adjacent to the coupling member and the distal portion is adjacent to the pipe; (i) wherein the weld zone joins the high Cu coupling member to the pipe; (ii) wherein the high Cu coupling member comprises at least about 0.5 wt. % Cu; and (b) thermally treating the weld zone; wherein after the thermally treating step, there exists an electrochemical potential difference of at least about 20 mV between the distal portion of the weld zone (e.g. low Cu weld zone) and the coupling member (high cu member).

In still another aspect of the invention, a pipe assembly is provided. The pipe assembly includes: a 7xxx series aluminum alloy pipe having a first end and a second end; at least one high Cu 7xxx series aluminum alloy coupling member at one of the first and second ends of the pipe; wherein each of the high Cu coupling member comprises at least about 0.5 wt % Cu; a weld zone between the end and the coupling member, wherein the weld zone joins the coupling member to the end; the weld zone comprising: a proximal portion; and a distal portion; wherein the proximal portion is adjacent to the coupling member and the distal portion is adjacent to the pipe; and wherein an electrochemical potential of at least about 20 mV exists between the distal portion of the weld zone and the coupling member.

In one aspect, a method of producing an assembly includes the steps of joining the high copper 7xxx series aluminum alloy member to the low copper 7xxx series aluminum alloy member. The low copper aluminum alloy member has general corrosion resistance (and/or resistance to pitting) which is sufficient for the member's use in corrosive environments. In some embodiments, the assembly is a pipe assembly. In one embodiment, the pipe assembly includes a pipe as the low copper member and a coupling member as the high copper member. In one embodiment, the pipe assembly is removably connectable to one or more pipe assemblies and/or devices. In this embodiment, each pipe has at least one coupling member attached to an end of the pipe. In one embodiment, each pipe has a coupling member at each end. In one embodiment, the pipes connected at their coupling members in an end-to-end axial configuration, to create a long series of piping useful in various applications. In these embodiments, the pipe assemblies have stress corrosion cracking (SCC) resistance in the coupling members, while the pipe has pitting and general corrosion resistance.

In one aspect of the invention, a method is provided. The method includes providing a welded assembly including a high copper 7XXX aluminum alloy member, a low copper 7XXX aluminum alloy member, and a weld zone; and controllably aging at least one of the high copper member and the weld zone to impart an overaged temper in the high copper member, wherein, due to the controllably aging step, there exists a corrosion potential difference between a low copper portion of the weld and the high copper member of from about 1 mV to about 50 mV. Controllably aging, as used herein, refers to regulating the amount of aging. For example, controllably aging includes aging the high copper member to an overaged condition, while maintaining as much strength in the high copper member as possible. In some embodiments, by controllably aging at least one of the high copper member and the weld, a corrosion potential difference of: at least about 1 mV; at least about 3 mV; at least about 5 mV; at least about 10 mV; at least about 15 mV; at least about 20 mV; at least about 25 mV; at least about 30 mV; at least about 35 mV; at least about 40 mV; at least about 45 mV; or at least about 50 mV is generated between the low copper weld zone and the high copper member (e.g. across the weld).

While various embodiments of the present invention have been described in detail, it is apparent that modifications and adaptations of those embodiments will occur to those skilled in the art. However, it is to be expressly understood that such modifications and adaptations are within the spirit and scope of the present invention. Various ones of the inventive aspects noted hereinabove may be combined to yield assemblies, methods of making assemblies, and pipe assemblies of the instant disclosure.

These and other aspects, advantages, and novel features of the invention are set forth in part in the description that follows and will become apparent to those skilled in the art upon examination of the following description and figures, or may be learned by practicing the invention.

### BRIEF DESCRIPTION OF THE DRAWINGS

FIG. 1 depicts a cross-sectional view of a schematic of an embodiment of an assembly (e.g. pipe assembly), where the pipe assembly is welded.

FIG. 2 depicts a cross-sectional view of a schematic of another embodiment of an assembly (e.g. pipe assembly), where the assembly is mechanically fastened.

FIG. 3 is a schematic of an embodiment with a close-up of the various zones in an embodiment of an assembly with a weld zone. Zone A depicts the high copper 7xxx parent metal; Zone B depicts the high copper heat-affected zone; Zone C depicts the high copper 7xxx weld zone; Zone D depicts the low copper weld zone; Zone E depicts the low copper 7xxx heat-affected zone; and Zone F depicts the low copper 7xxx parent metal.

FIG. 4 is a graph of the measured Potential vs SCE (in volts) by the distance from the weld center line (in mm) of the weld zones depicted in FIG. 3, shown for five different aging practices.

FIG. 5 is a schematic of boiling salt water SCC test specimens of Alloy A-Alloy B FSW joints with respect to the weld zone, as detailed in the Examples section.

FIG. 6 is a schematic of alternate immersion and constant immersion SCC test specimens of Alloy A-Alloy B FSW joints with respect to the weld zone, as detailed in the Examples section.

FIG. 7 is a macrograph of the Alloy B-Alloy A FSW joint.

FIG. 8 is a graph depicting the post-weld-aging (“PWA”) curves for Alloy B tube to Alloy A tube FSW joints at 320 F and 330 F.

FIG. 9 is hardness profile of the Alloy A FSW to Alloy B, shown before and after PWA near the OD.

FIG. 10 is microhardness profiles for as-welded and PWA (18 hours/320 F) Alloy B-Alloy A FSW joints at t/e.

FIG. 11 is hardness profile before and after PWA near the ID.

FIG. 12 is optical cross section of a boiling salt water SCC test specimens showing the different zones of the Alloy B-Alloy A FSW joint.

FIG. 13 is a graph depicting the solution potential profiles of Alloy B-Alloy A FSW joints as a function of post-weld-aging cycle.

FIG. 14 (a) and (b) are graphs depicting the aging curves of an Alloy B forging at 315 F and 325 F.

FIG. 15 (a) and (b) are graphs depicting the aging curves of Alloy A extrusion at 315 F and 325 F.

FIG. 16 is anodized micrograph of the Alloy A-Alloy B FSW joint. The Alloy B Forged coupling is on the left and the Alloy A extruded pipe is on the right.

FIG. 17 is a graph depicting micro hardness profiles of Alloy B-Alloy A FSW joints in the as-welded and PWA conditions.

FIG. 18 is corrosion potential profiles of Alloy B-Alloy A FSW joints in the as-welded and PWA conditions.

FIG. 19 is corrosion potential profiles of Alloy B-Alloy A FSW joints as a function of PWA time at 315 F.

FIG. 20 is corrosion potential profiles of Alloy B-Alloy A FSW joints as a function of PWA time at 325 F.

FIG. 21 is G110 type-of-attack samples showing pitting corrosion on the C22N parent metal and the C22N side of the Heat-Affected-Zone. (a) PWA at 315 F for 18 hours, (b) PWA at 315 F for 32 hours.

FIG. 22 is G110 type-of-attack samples showing pitting corrosion on the C22N parent metal and the C22N side of the Heat-Affected-Zone. (a) PWA at 325 F for 18 hours, (b) PWA at 325 F for 32 hours.

FIG. 23 is a cross section of Alloy A after the G110 Type-of-Attack testing which exhibits that there was no pitting or intergranular corrosion attach observed for Alloy A (low Cu 7XXX series aluminum alloy), with an aging practice of 250 F for 6 hours+315 F for 18 hours

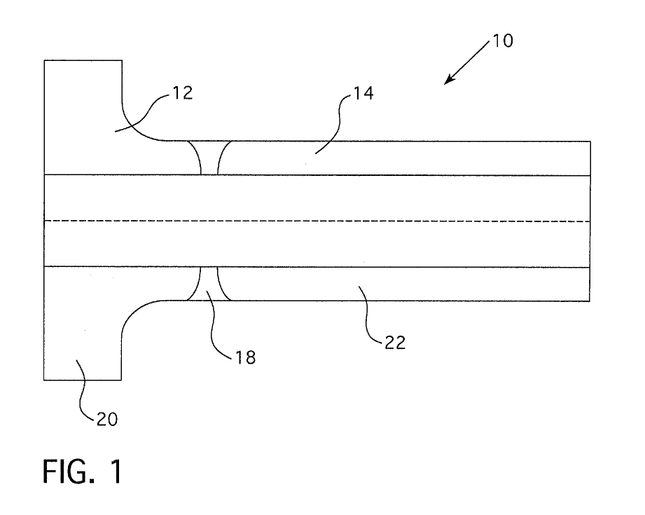

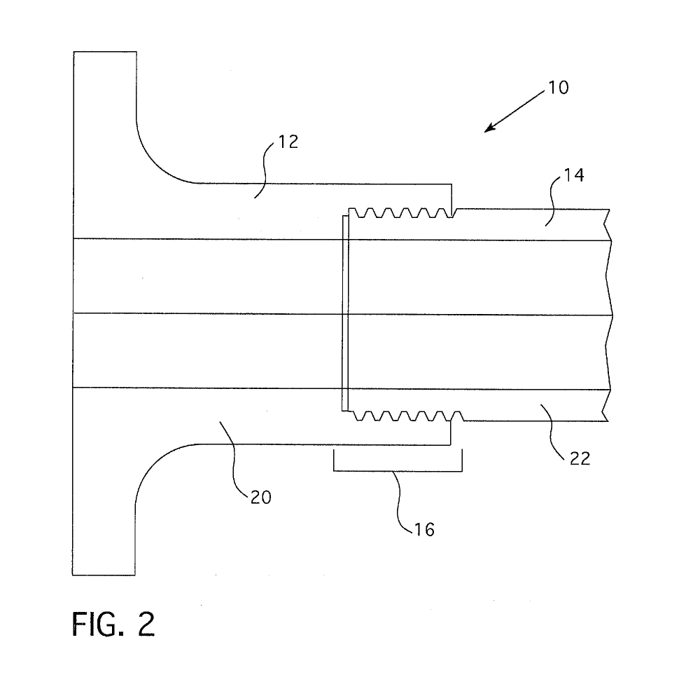

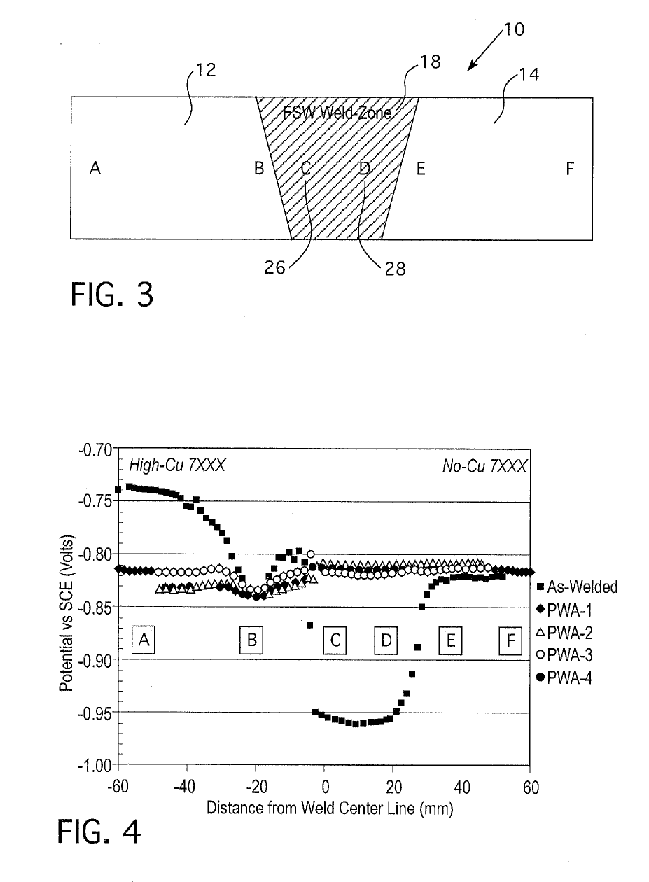

### EXAMPLES

Samples of Alloy A, a low Cu alloy, and Alloy B, a high Cu alloy were evaluated in order to determine the tensile strengths and stress corrosion cracking of the samples (parent metals and welded samples) in different aging conditions (e.g. as-welded/no post-weld aging and several post weld aging conditions). The compositional limits of the Alloy A and Alloy B are set forth below in Table 1.

TABLE 1
Compositional limits of Alloy A and Alloy B

| Alloy | Si | Fe | Cu | Mn | Mg | Cr | Zn | Zr |
|---|---|---|---|---|---|---|---|---|
| Alloy A | <0.2 | <0.3 | <0.08 | 0.30-0.50 | 2.0-2.6 | 0.10-0.20 | 4.0-4.8 | 0.10-0.18 |
| Alloy B | <0.15 | <0.13 | 1.3-2.0 | <0.04 | 1.2-1.8 | <0.04 | 7.0-8.0 | 0.08-0.15 |

Tensile Strength tests were conducted on the Alloy A forgings. Tensile tests were conducted using near full thickness (˜19 mm) straight flat specimens with a skim pass on OD and ID. The dimensions of the tensile specimens were 6.35 mm thick, 19 mm wide (through thickness) and 305 mm long. A 4 in extensometer was used for all tensile testing. Tensile tests on samples of Alloy A were conducted with two different aging practices, as set forth in Table 2 below, a near-peak age T7X and an overaged temper T7Y. The tensile properties were evaluated in all three directions (ST, L, and LT).

TABLE 2
Typical properties of the first article Alloy A-T7X and
overaged Alloy A-T7Y hand forgings

| Alloy | Alloy A T7X¹ | Alloy A-T7Y² |
|---|---|---|
| Product | Hand Forging | Hand Forging |
| Gage | 203 mm | 203 mm |
| Basis | Typical | Typical |
| TYS, L | 383.3 | 308.9 |
| (MPa) | | |
| UTS, L | 434 | 362.7 |
| (MPa) | | |
| % El, L | 13 | 16.0 |
| TYS, LT | 383.3 | 304.1 |
| (MPa) | | |
| UTS, LT | 435.8 | 369.6 |
| (MPa) | | |
| % El, LT | 12 | 14.0 |
| TYS, ST | 355.8 | 288.9 |
| (MPa) | | |
| UTS, ST | 418.6 | 362.0 |
| (MPa) | | |
| % El, ST | 8 | 10.0 |

¹Age practice: 24 hours at 250 F. + 2 hours at 350 F.
²Age practice: 24 hours at 250 F. + 6 hours at 350 F.

The typical TYS was ˜386 MPa for L and LT directions and was ˜359 MPa in the ST direction. Additional aging at 350 F for 4 hours reduced the TYS in all directions by ˜69-76 MPa.

Stress corrosion tests were conducted on the Alloy A forgings. Stress corrosion tests were done in boiling salt water according to ASTM G103 (“Practice for evaluating stress corrosion cracking resistance of low copper 7xxx series Al—Zn—Mg—Cu alloys in boiling 6% sodium chloride solution”). The specimens were 0.125 mm diameter in a T-Bar configuration. All three directions were tested at three stress levels: 120.7 MPa, 159 MPa and 224.1 MPa. The total test period was 35 days. The results of the SCC tests are summarized in Table 3. The forging piece was also macro-etched to determine the grain orientations with respect to loading directions. The radial axis corresponds to the short longitudinal (ST). The radial axis corresponds to the long-transverse (LT), and the circumferential corresponds to the longitudinal (L) with respect to grain orientation.

TABLE 3
6% NaCl, Boiling Salt Water SCC data for the Alloy A-T7X and T7Y hand forgings.

| | Gauge | | Stress | Days to Fail | | | |
|---|---|---|---|---|---|---|---|
| | (mm) | Orientation: | (MPa): | Specimen 1 | Specimen 2 | Specimen 3 | Specimen 4 |
| T7X | 203 | ST | 224.1 | 0.17 | 0.08 | 0.08 | 0.08 |
| | | | 159 | 0.92 | 0.17 | 0.17 | |
| | | | 120.7 | 0.92 | 3.02 | 0.17 | |
| T7X | 203 | LT | 224.1 | OK | OK | OK | OK |
| | | | 159 | OK | OK | OK | |
| | | | 120.7 | OK | OK | OK | |
| T7X | 203 | L | 224.1 | OK | OK | OK | OK |
| | | | 159 | OK | OK | OK | |
| | | | 120.7 | OK | OK | OK | |
| T7Y | 203 | ST | 224.1 | 0.08 | 0.17 | 0.92 | 0.08 |
| | | | 159 | 0.92 | 0.17 | 2.02 | |
| | | | 120.7 | 0.17 | 0.92 | 3.02 | |
| T7Y | 203 | LT | 224.1 | OK | OK | OK | OK |
| | | | 159 | OK | OK | OK | |
| | | | 120.7 | OK | OK | OK | |
| T7Y | 203 | L | 224.1 | OK | OK | OK | OK |
| | | | 159 | OK | OK | OK | |
| | | | 120.7 | OK | OK | OK | |

As expected, out of the three dimensions tested, the ST direction was found to be the most susceptible to SCC regardless of the stress level and the amount of averaging. All of the L and LT specimens passed the test with 35 days of exposure regardless of the aging condition or the stress level. All of the ST specimens failed, with most failing in less than a day.

A second of specimens were tested in the ST direction at lower stress levels (69, 86.2 and 103 MPa). The same diameter and sample sizes were used as in the previous test. As expected and shown in Table 4, all of these specimens failed, with three of the nine lasting several days before failure. The sample was a 203 mm gauge, measured in the ST direction/orientation. The test spanned 6 days.

TABLE 4
6% NaCl, Boiling Salt Water SCC data for the Alloy A hand forgings

| Stress | Days to Fail | | |
|---|---|---|---|
| (MPa): | Specimen 1 | Specimen 2 | Specimen 3 |
| 69 | 4 | 4 | 0.82 |
| 86.2 | 0.82 | 0.82 | 0.82 |
| 103 | 5.95 | 0.82 | 0.82 |

These tests showed that Alloy A is SCC succeptable if configured so that it is loaded in an ST direction.

Alloy A was also evaluated in specimens taken from an extruded tube. The tensile properties of the Alloy A extruded tube were evaluated in the longitudinal direction (e.g. 33.0 mm thick, 556.3 mm OD) and the typical tensile properties are set forth below in Table 5.

TABLE 5
Typical tensile properties of the 33 mm Alloy A extruded pipe in the T7X
and the overaged T7Z temper

Alloy

| | |
|---|---|
| Alloy A-T7X¹ | Alloy A-T7Z² |

Gage

| | 33 mm | 33 mm |
|---|---|---|
| L TYS | 434 | 341.2 |
| (MPa) | | |
| L UTS | 486.1 | 411.0 |
| (MPa) | | |
| % El | 13 | 16 |

¹250 F. for 24 hrs, then age at 350 F. for 2 hrs.
²250 F. for 24 hrs, then age at 350 F. for 5 hrs

The average TYS based on five replicate specimens was 434 MPa. The UTS was ˜490 MPa with 13% elongation. The extruded pipe was then additionally aged for 3 hours at 350 F. In the overaged condition, the TYS dropped to ˜345 MPa and the UTS was ˜414 MPa with 16% elongation.

Stress corrosion cracking tests were conducted on the Alloy A-T7X Extrusion in 6% NaCl boiling salt water according to ASTM G103 in both the T7X and the overaged temper (T7Z) in the ST direction at 111.7 and 172 MPa. Sample 1 was the T7X aging practice of Table 5, while sample 2 was the T7Z aging of Table 5.

TABLE 6
6% NaCl, Boiling Salt Water SCC data for the Alloy A-T7X extrusions in the ST direction

| | Gauge | | Stress | Days to Fail | | | | |
|---|---|---|---|---|---|---|---|---|
| Sample | (mm) | Orientation | (MPa): | Specimen 1 | Specimen 2 | Specimen 3 | Specimen 4 | Specimen 5 |
| 1 | 33.0 | ST | 111.7 | 0.12 | 0.12 | 0.15 | 0.12 | 0.15 |
| | | | 172 | 0.04 | 0.15 | 0.17 | 0.12 | 0.17 |
| 2 | 33.0 | ST | 111.7 | 0.12 | 0.12 | 0.12 | 0.04 | 0.12 |
| | | | 172 | 0.15 | 0.15 | 0.17 | 0.12 | 0.12 |

As expected, specimens failed within 1 day regardless of the aging condition and the stress.

The Alloy A-T7X tubes were also tested in the LT direction. All specimens passed the test with 17 days of exposure.

TABLE 7
6% NaCl, Boiling Salt Water SCC data for the Alloy A-T7X extrusions in the LT direction

| Gauge | | Stress | Days to Fail | | | | |
|---|---|---|---|---|---|---|---|
| (mm) | Orientation | (MPa): | Specimen 1 | Specimen 2 | Specimen 3 | Specimen 4 | Specimen 5 |
| 33.0 | LT | 111.7 | OK | OK | OK | OK | OK |
| | | 172 | OK | OK | OK | OK | OK |

Alloy A was friction stir welded to itself (alloy A tube to alloy A tube) and aged at different conditions to evaluate tensile and SCC performance. Tensile tests were conducted using near full thickness straight flat specimens with a skim pass on OD and ID. The dimensions of the tensile specimens were 6.35 mm thick, ˜33.0 mm wide (through thickness) and 305 mm long. A 102 mm extensometer was used for all testing. Double-shoulder T-bars (51 mm length) were used for all SCC testing and the specimens were centered around the weld zone at the t/2 location. Results are depicted in Table 8 below,

TABLE 8
Tensile and electrical conductivity properties of Alloy A-Alloy A FSW
joints

| | TYS | UTS | |
|---|---|---|---|
| | (MPa) | (MPa) | % El |
| Aging Time at 330 F.* | | | |
| 0 | 290.3 | 402.7 | 6.0 |
| 8 | 336.5 | 394.4 | 6.8 |
| 12 | 329.6 | 390.0 | 8.5 |
| 16 | 321.0 | 386.1 | 10.5 |
| 24 | 310.0 | 54.6 | 15.5 |
| Aging Time at 350 F.* | | | |
| 0 | 290.3 | 402.7 | 6.0 |
| 1 | 340.7 | 376.4 | 4.5 |
| 3 | 333.1 | 393.0 | 5.0 |
| 5 | 321.0 | 385.4 | 6.0 |
| 7 | 312.3 | 379.2 | 9.3 |

*All specimens received a first step aging at 250 F. for 6 hours

6% NaCl, Boiling Salt Water SCC tests were conducted in a PWA temper of 18 hours at 320 F in the longitudinal direction (i.e. across the weld zone) at 155.1 MPa, 207 MPa, 241 MPa and 276 MPa. As expected, all specimens failed within 1 day regardless of the stress level (Table 9). Though not bound to any mechanism or theory, one expectation of the SCC susceptibility is that the fine equiaxed grain structure of the weld zone behaves like as ST orientation.

TABLE 9
6% NaCl, Boiling Salt Water SCC data for the Alloy A-7X tube-to tube
FSW joints

| Gauge | Orienta- | Stress | Days To Failure | | |
|---|---|---|---|---|---|
| (mm) | tion: | (MPa): | Specimen 1 | Specimen 2 | Specimen 3 |
| 33.0 | L | 155.1 | 0.25 | 1 | 0.17 |
| | | 207 | 0.17 | 0.17 | 0.25 |
| | | 241 | 0.17 | 0.17 | 0.17 |
| | | 276 | 0.17 | 0.17 | 0.17 |

### Alloy A/Alloy B Tube-to-Tube FSW Joints:

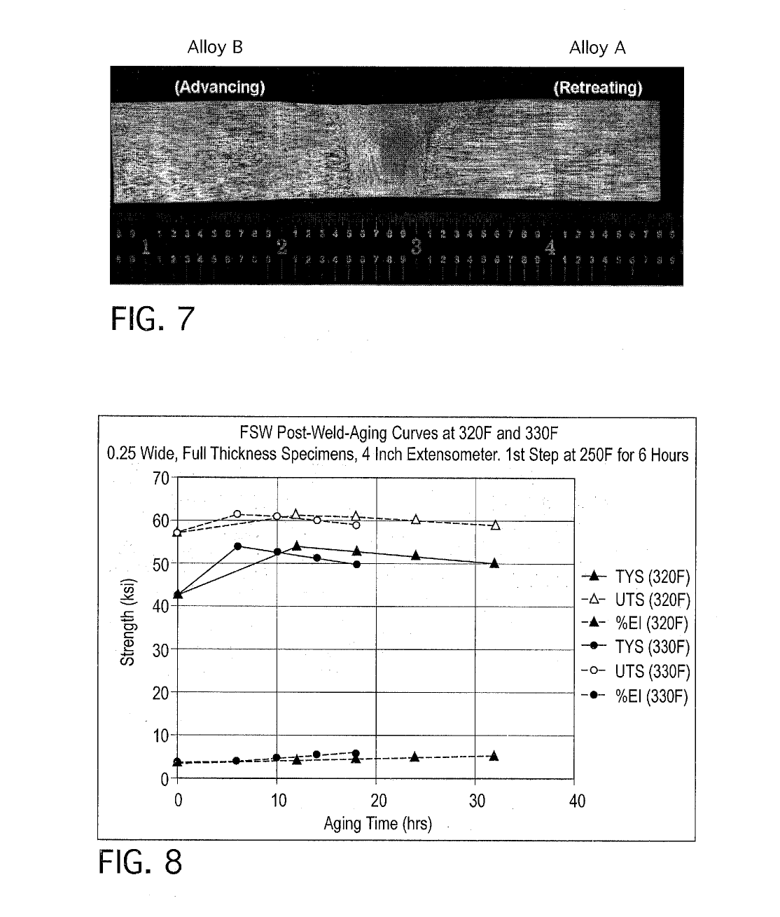

Alloy A-T7X was friction stir welded to Alloy B-T6. Samples of Alloy B, an extruded tube, (e.g. 39.87 mm thick tubes with 485.40 mm ID and 569.97 mm OD) were prepared. The Alloy B samples were then aged to the T6 temper (e.g. aging between 240-255 F for 6 hours) and the ID and OD of the tubes were machined to a final thickness of 20 mm. Post-weld aging curves were generated for the FSW samples at two temperatures: 320 F for up to 32 hours and at 330 F for up to 18 hours, with a first step age at 250 F for 6 hours. Tensile tests were conducted using near full thickness (˜19 mm) straight flat specimens with a skim pass on OD and ID. The dimensions of the tensile specimens were 6.35 mm thick, 19 mm wide (through thickness) and 305 mm long. A 102 mm extensometer was used for all tensile testing. FIG. 7 shows the macrograph of the Alloy B/Alloy A bi-alloy FSW joints. Alloy B is on the advancing side and Alloy A is on the retreating side of the weld.

The PWA studies were carried out at 320 F and 330 F with a constant first step of 6 hours at 250 F. The tensile results are tabulated in Table 10 and also plotted in FIG. 8.

TABLE 10
Tensile and electrical conductivity properties of Alloy A to Alloy B-T6
FSW joints

| | TYS | UTS | |
|---|---|---|---|
| | (MPa) | (MPa) | % El |
| Aging Time at 320 F.* | | | |
| 0 | 294.4 | 395.8 | 3.7 |
| 12 | 372.3 | 423.3 | 4.4 |
| 18 | 365.4 | 419.9 | 4.7 |
| 24 | 356.4 | 415.1 | 5.0 |
| 32 | 344.0 | 406.8 | 5.3 |
| Aging Time at 330 F.* | | | |
| 0 | 294.4 | 395.8 | 3.7 |
| 6 | 372.3 | 423.3 | 4.1 |
| 10 | 363.3 | 419.9 | 4.9 |
| 14 | 353.7 | 414.3 | 5.5 |
| 18 | 343.3 | 407.4 | 5.9 |

*All specimens received a first step aging at 250 F. for 6 hours

The as-welded TYS of the joint was 294.4 MPa. The peak strength in the PWA temper was achieved with 12 hours of second step aging at 320 F or with 6 hours of aging at 330 F. The tensile properties were ˜372 MPa TYS, 421 MPa UTS with 4% elongation. The TYS increased by ˜76 MPa after the post-weld-aging. The peak strength corresponds to 92% weld efficiency based on the parent metal strength of the Alloy A alloy (405.4 MPa TYS).

Table 11 summarizes the post weld aging (PWA) practices selected for further characterization.

TABLE 11
Post-Weld-Age cycles

| | Step 1 | Step 2 |
|---|---|---|
| PWA-1 | 250 F./6 hrs | 320 F./18 hrs |
| PWA-2 | | 320 F./32 hrs |
| PWA-3 | | 330 F./10 hrs |
| PWA-4 | | 330 F./18 hrs |

The parent metal properties for PWA-1 though PWA-4 are summarized in Tables 12 and 13, for Alloy B and Alloy A alloys, respectively.

TABLE 12
As-welded and PWA tensile properties of Alloy B-T6 parent extrusion

| | TYS, L | UTS, L | |
|---|---|---|---|
| | (MPa) | (MPa) | % El, L |
| As-Welded | 531.6 | 603.3 | 14 |
| PWA-1 | 455.8 | 504.7 | 14 |
| PWA-2 | 421.3 | 480.6 | 16 |
| PWA-3 | 464.7 | 510.0 | 15.5 |
| PWA-4 | 419.2 | 479.9 | 16 |

TABLE 13
As-welded and PWA tensile properties of Alloy A parent extrusion

| | TYS, L | UTS, L | |
|---|---|---|---|
| | (MPa) | (MPa) | % El, L |
| As- | 434.4 | 486.1 | 13 |
| Welded | | | |
| PWA-1 | 368.9 | 438.5 | 14 |
| PWA-2 | 350.3 | 424.0 | 15.5 |
| PWA-3 | 370.0 | 439.2 | 14 |
| PWA-4 | 346.9 | 422.7 | 14.5 |

PWA-1 and PWA-3 result in a very similar tensile strength but at two different aging temperatures (320 F and 330 F). Similarly, PWA-2 and PWA-4 also achieve similar amount of overaging based on tensile results.

The TYS for Alloy B is ˜462 MPa after the PWA-1 and PWA-3 practices and it is ˜421 MPa for the PWA-2 and PWA-4 practices. For Alloy A, the TYS was ˜372 MPa and ˜352 MPa for the same aging practices. The TYS difference between the as-welded and the most overaged PWA tempers (i.e. PWA-2 and PWA-4) is about 110 MPa for the Alloy B alloy. The same PWA practices reduces the Alloy A parent metal TYS by only ˜55 MPa, which may indicate slower overaging kinetics for Alloy A.

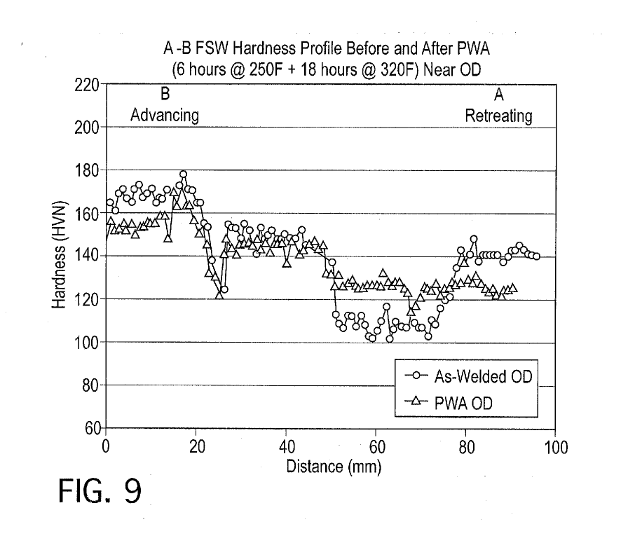

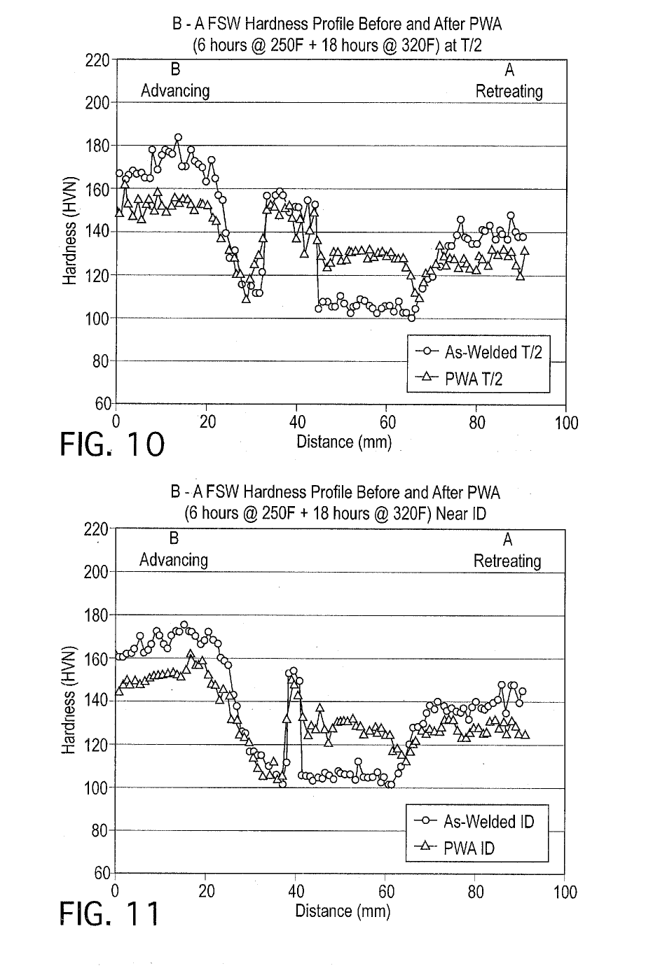

The hardness profiles of FSW joints were also measured in the as-welded and the PWA-1 condition (i.e. 320 F/18 hours). The measurements were done across the weld zone at three locations through the thickness: near the OD surface (FIG. 9), at t/2 and near the ID surface (FIG. 11). Though not being bound to any mechanism or theory, referring to FIG. 10, it appears that the FSW process may not mix the two different alloys in the weld zone to create a “mixed alloy”. The FSW joint has two distinct zones that correspond to Alloy B and Alloy A alloys. As shown in FIG. 9, these two zones have similar widths near the OD with higher hardness values on the Alloy B side of the weld zone than the Alloy A side.

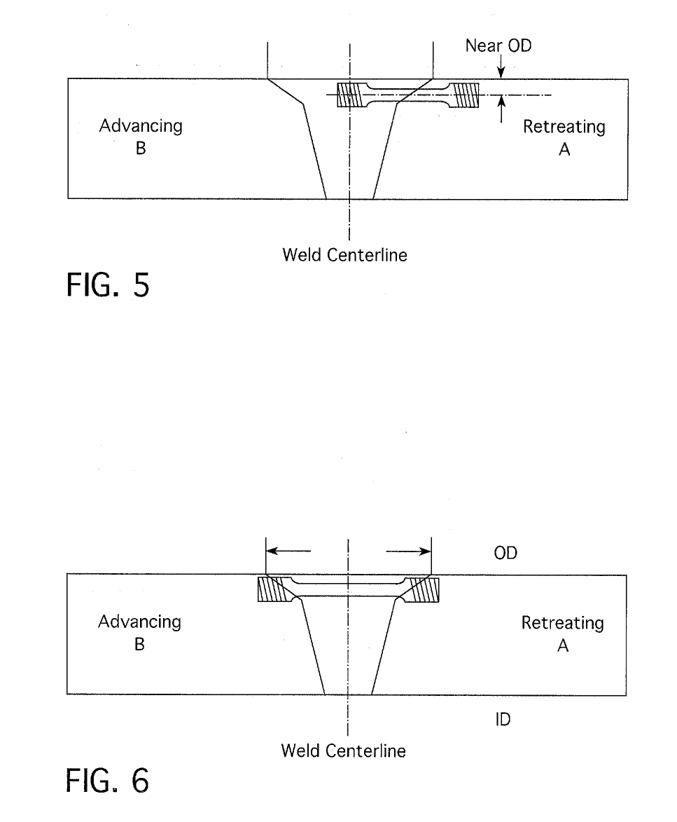

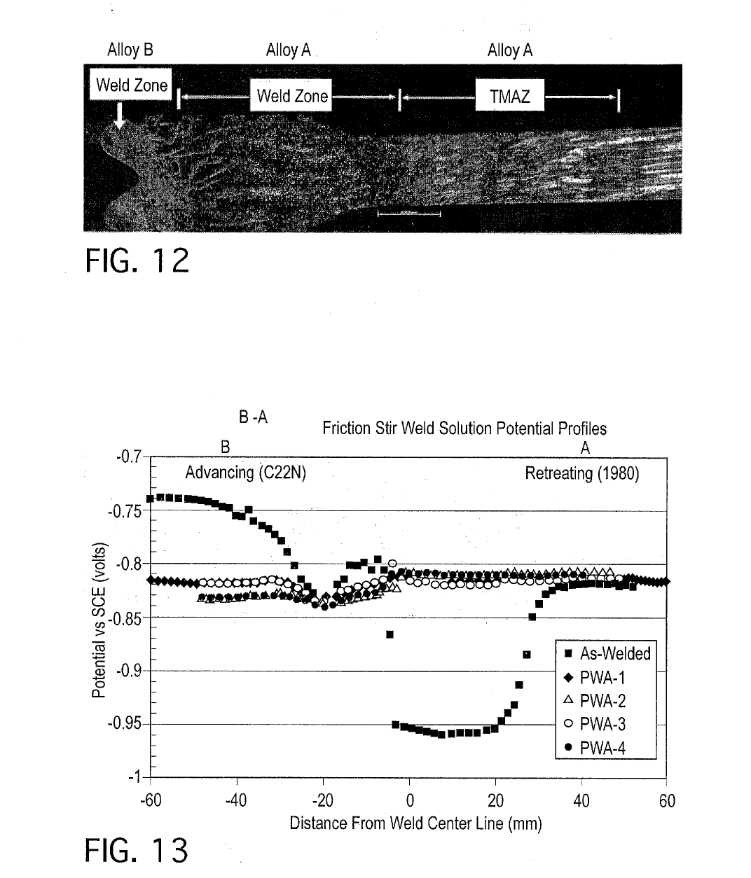

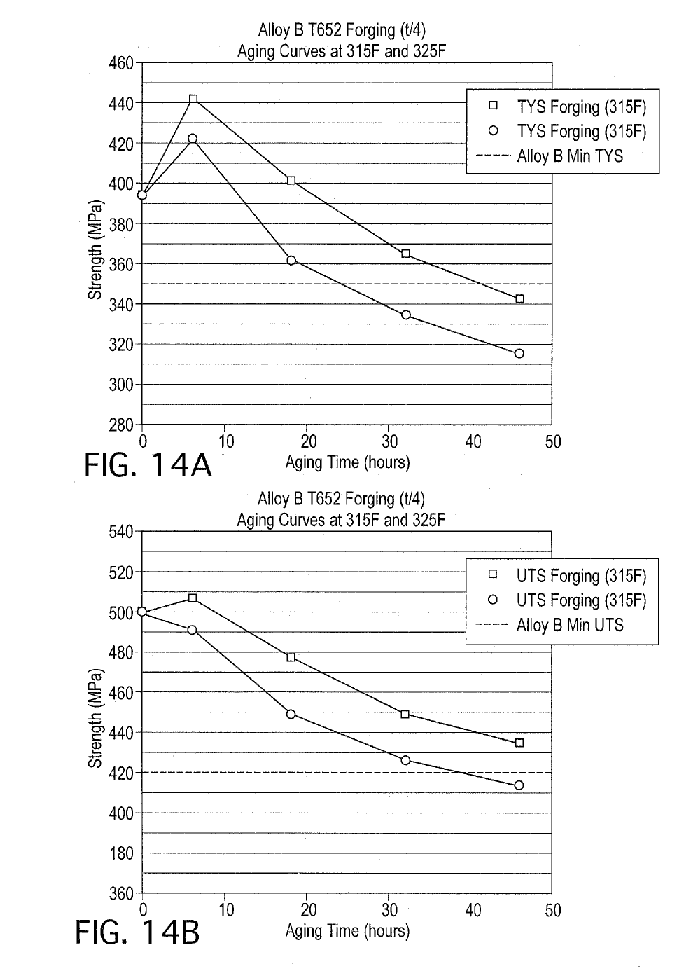

The Alloy A side of the weld zone (Cu-free) was assessed by the 6% NaCl boiling salt test and the Alloy A weld zone was assessed using test specimens that were positioned such that the gage section only contained the Alloy A alloy, as schematically shown in FIG. 5. FIG. 12 is the anodized cross section of one of the SCC specimens, which shows the relative position of the Alloy A weld zone with respect to the gage length. Note that the Alloy B weld zone is present only in the last couple of threads, which are not typically loaded. Most, if not all of the loading is sustained in the first few threads that are close to the gage length.

Table 14 summarizes the results of the boiling salt water testing for the previously discussed post-weld-aging conditions (i.e. PWA-1 through PWA-4). The specimens were all 20 mm gauge, measured across the weld zone. The length of the test was 21 days.

TABLE 14
6% NaCl, Boiling Salt Water SCC data across the weld for the Alloy A
side of the A-B FSW joint.

| | Stress | Days to Fail | | |
|---|---|---|---|---|
| PWA | (MPa): | Specimen 1 | Specimen 2 | Specimen 3 |
| 1 | 155.1 | 20.8 | 0.25 | |
| | 207 | 0.25 | 21 | 0.79 |
| 2 | 155.1 | OK | OK | 0.79 |
| | 207 | OK | 21 | 21 |
| 3 | 155.1 | 21 | OK | OK |
| | 207 | 0.79 | 1.18 | 0.79 |
| 4 | 155.1 | OK | 1.18 | 8.81 |
| | 207 | OK | 10.79 | OK |

In the PWA-1 condition at 155.1 MPa, one specimen made it very close to the end of the test, which the other failed quickly, and in the PWA-1 207 MPa samples, two out three specimens failed almost immediately at 207 MPai while one sample made it to 21 days. For PWA-2, two out of the three 155.1 MPa samples passed, and almost all of the samples at the 207 MPa made it past 20 days. For PWA-3 all three specimens at 155.1 MPa made it to 21 days, with 1 failing before the end of day 21. For the PWA-3 at 207 MPa, all three samples failed within the first two days. For PWA-4 at 155.1 MPa, one sample passed the test, while at 207 MPa, two out of three samples passed. Note that PWA-1 and PWA-3 have less overaging than PWA-2 and PWA-4. These results indicate that the more overaged PWA-2 and PWA-4 tempers seemingly have better SCC resistance in the Alloy A weld zone.

A second set of boiling salt water tests were conducted on Alloy B/Alloy A FSW joints with the more SCC susceptible PWA-1 and PWA-3 tempers. This time, however, the SCC samples were electrically connected to Alloy B parent metal “anodes” that were aged at 320 F for 32 hours (i.e. the more overaged PWA-2 practice). Without being bound to any particular mechanism or theory, the Alloy B parent metal was attached to determine if it had any effect on (i.e. whether it could prevent) SCC failures in the Alloy A weld zone. The Alloy A weld zone was SCC susceptible when tested without any anodes. The samples were all 20 mm gauge, and were tested across the weld. The total test length was 9 days. The results of the boiling salt-water tests are given in Table 15.

TABLE 15
6% NaCl, Boiling Salt Water SCC data across the weld for the Alloy A
weld zone of A-B FSW joints coupled with Alloy B

| | Stress | Days to Fail | | |
|---|---|---|---|---|
| PWA | (MPa): | Specimen 1 | Specimen 2 | Specimen 3 |
| 1 | 207 | OK | OK | OK |
| 3 | 207 | 0.83¹ | OK | OK |

¹It was determined the reason for failure was that the anode was not properly connected to the specimen during the test.

Six specimens were tested at 207 MPa and five of them passed the test with 9 days of exposure. One specimen failed within one day, but the post-test analysis of the testing fixture revealed that the anode for this specimen was not properly connected. This test showed that with Alloy B electrically connected to the Alloy A weld zone, all samples that were properly electrically connected passed.

The Alloy B side of the weld-zone was evaluated in 3.5% NaCl Alternate Immersion (AI) testing in both the as-welded and the four PWA conditions. The specimens were all 20 mm gauge, and were tested across the weld. The length of the test was 366 days. The results are summarized in Table 16.

TABLE 16
3.5% NaCl Alternate Immersion SCC data across the weld for the Alloy B
weld zone of A-B FSW joints

| PWA | Stress | Days to Fail | | |
|---|---|---|---|---|
| practice | (MPa): | Rep 1 | Rep 2 | Rep 3 |
| As-welded | 103 | OK | OK | OK |
| | 155.1 | 46 | OK | OK |
| | 207 | 10 | 22 | 22 |
| 1 | 103 | OK | OK | OK |
| | 155.1 | OK | OK | OK |
| | 207 | OK | OK | OK |
| 2 | 103 | OK | OK | OK |
| | 155.1 | OK | OK | OK |
| | 207 | OK | OK | OK |
| 3 | 103 | OK | OK | OK |
| | 155.1 | OK | OK | OK |
| | 207 | OK | OK | OK |
| 4 | 103 | OK | OK | OK |
| | 155.1 | OK | OK | OK |
| | 207 | OK | OK | OK |

All the post-weld-aged specimens survived 366 days in the AI testing with stress levels up to 207 MPa, regardless of the post-weld-age condition. The as-welded joint, on the other hand, was susceptible to SCC at stress levels of 155.1 MPa and 207 MPa.

The as-welded and post-weld-aged joints were also tested in the Simulated Sea-Water “Constant Immersion” testing in an ASTM sea-water environment and the results are given in Table 17. The specimens were a 20 mm gauge, and were tested across the weld. All specimens, including the as-welded specimens, were ok (passed) the test after 369 days of exposure.

TABLE 17
“Modified Alternate Immersion Constant Immersion Simulated Seawater
Environment” ASTM sea-water SCC data across the weld for the
Alloy A-Alloy B FSW joints

| PWA | Stress | Days to Fail | | |
|---|---|---|---|---|
| practice | (MPa): | Specimen 1 | Specimen 2 | Specimen 3 |
| As- | 103 | OK | OK | OK |
| welded | 155.1 | — | OK | OK |
| | 207 | OK | OK | OK |
| 1 | 103 | — | OK | OK |
| | 155.1 | OK | OK | OK |
| | 207 | OK | OK | OK |
| 2 | 103 | OK | OK | OK |
| | 155.1 | OK | OK | OK |
| | 207 | OK | OK | OK |
| 3 | 103 | OK | OK | OK |
| | 155.1 | OK | OK | OK |
| | 207 | OK | OK | OK |
| 4 | 103 | OK | OK | OK |
| | 155.1 | OK | OK | OK |
| | 207 | OK | OK | OK |

The corrosion potential profiles were generated for the as-welded and the four PWA conditions. The results are shown in FIG. 13. The corrosion profile of the as-welded FSW joint shows that the weld zone has the lowest corrosion potential (i.e. more anodic) with respect to both parent metals and the HAZ. Post-weld-aging significantly increases the corrosion potential of the weld zone (−960 mV to −815 mV), while the Alloy B parent metal potential decreases by ˜80 mV. The corrosion potential of the Alloy A parent metal shows that it does not have any significant change with post-weld-aging. It should be noted that the corrosion potential difference between the parent metal and the Alloy B side of the HAZ is ˜20 mV after PWA-1 and PWA-3, and even smaller after PWA-2 and PWA-4. Thus, it appears that the PWA practices reduce the corrosion potential difference across the weld zone. This may in turn minimize the galvanic interaction between different zones of the FSW joint. For PWA-1 and PWA-3, the two potentials very close at −815 mV. However, for PWA-2 and PWA-4, the Alloy B parent metal corrosion potential becomes slightly lower than the weld zone slightly anodic with respect to the weld zone (i.e. −835 mV for Alloy B vs. −810 mV for Alloy A weld zone). Though not to any particular thing or mechanism, one explanation is that in the vicinity of an electrolyte (e.g. the boiling salt-water test environment) the Alloy B parent metal is galvanically protecting the Alloy A weld zone, which in turn improves its SCC resistance.

Another set of experiments was run, with the parent Alloy B material in a different temper (e.g. T652). Alloy A and Alloy B for this set of experiments falls under the same compositional limits listed in Table 1. The Alloy B forging samples used in this set of experiments was in a T652 temper, which was essentially solution heat treated, quenched, stress relieved and artificially aged to near peak-strength temper. Forged couplings were made into 2 different shapes, shape A (“Forging A”) and shape B (“Forging B”). Forging A was at a nominal thickness of 127 mm and Forging B was at a nominal thickness of 203 mm. Both forgings were machined down to a thickness of 21 mm with an ID of 690 mm.

The Alloy A extruded tube samples used in this set of experiments was solution heat treated, quenched, stress relieved and artificially aged temper similar to a peak aged (T6) or a slightly overaged (T79) temper in the AA standards. The ID of the tube was 690 mm with a nominal thickness of 21 mm. Quarter sections of a tube from the front, middle and rear of the extrusion were subsequently characterized. The Alloy B forged tube was friction stir welded to the Alloy A extruded tube in four full ring FSW joints. Two welds included shape A as the coupling in the coupling-to-pipe joints and the other included shape B as the coupling in the coupling-to-pipe joints.

Tensile testing was performed on forgings (parent materials), extrusions parent material) and the FSW joints according to the test matrix listed in Table 18. Testing tests were conducted according to the ASTM E8 and B557 standards.

TABLE 18
Tensile testing matrix.

| | Longitudinal | | | | | | Circumferential | | | Radial |
|---|---|---|---|---|---|---|---|---|---|---|
| | OD | t/4 | t/2 | 3t/4 | ID | Full | t/4 | t/2 | 3t/4 | t/2 |
| Forging | ✓ | ✓ | ✓ | ✓ | ✓ | | ✓ | ✓ | ✓ | ✓ |
| Extrusion | | | ✓ | | | | | ✓ | | |
| FSW Joint | | | | | | ✓ | | | | |

A post-weld-age practice (6 hours at 250 F (121 C)+18 hours at 325 F (163 C)) was selected for the tensile characterization study. Table 19 summarizes the results of the tensile tests. It should be noted that the reported values are the average of two tests per location.

TABLE 19
Tensile test results of the forgings and extrusions

| | | | TYS | UTS | |
|---|---|---|---|---|---|
| | Direction | Location | (MPa) | (MPa) | % El |
| Alloy B Forging A | ST | OD | 373 | 456 | 8.0 |
| | | t/4 | 366 | 450 | 6.3 |
| | | t/2 | 369 | 451 | 6.0 |
| | | 3t/4 | 370 | 451 | 6.3 |
| | | ID | 377 | 455 | 7.3 |
| | L | t/4 | 412 | 473 | 10.8 |
| | | t/2 | 404 | 471 | 10.3 |
| | | 3t/4 | 400 | 469 | 10.8 |
| | LT | t/2 | 401 | 464 | 8.8 |
| Alloy B Forging B | ST | OD | 369 | 462 | 7.5 |
| | | t/4 | 368 | 455 | 5.5 |
| | | t/2 | 363 | 449 | 4.3 |
| | | 3t/4 | 356 | 439 | 3.5 |
| | | ID | 372 | 459 | 5.8 |
| | L | t/4 | 415 | 479 | 9.5 |
| | | t/2 | 412 | 476 | 10.5 |
| | | 3t/4 | 403 | 468 | 10.8 |
| | LT | t/2 | 394 | 457 | 5.3 |
| Alloy A Front | ST | t/2 | 328 | 401 | 15 |
| Extrusion | L | t/2 | 323 | 398 | 14.8 |
| Alloy A Rear | ST | t/2 | 323 | 398 | 14.8 |
| Extrusion | L | t/2 | 314 | 389 | 15.5 |
| Alloy A Middle | ST | t/2 | 331 | 403 | 15.2 |
| Extrusion | L | t/2 | 318 | 391 | 15 |

Note:
Reported values are the average of two tests per location

The strength of the Alloy B parent material exceeded: 350 MPa TYS, 420 MPa UTS and the strength of the Alloy A material exceeded: 310 MPa TYS, 345 MPa UTS.

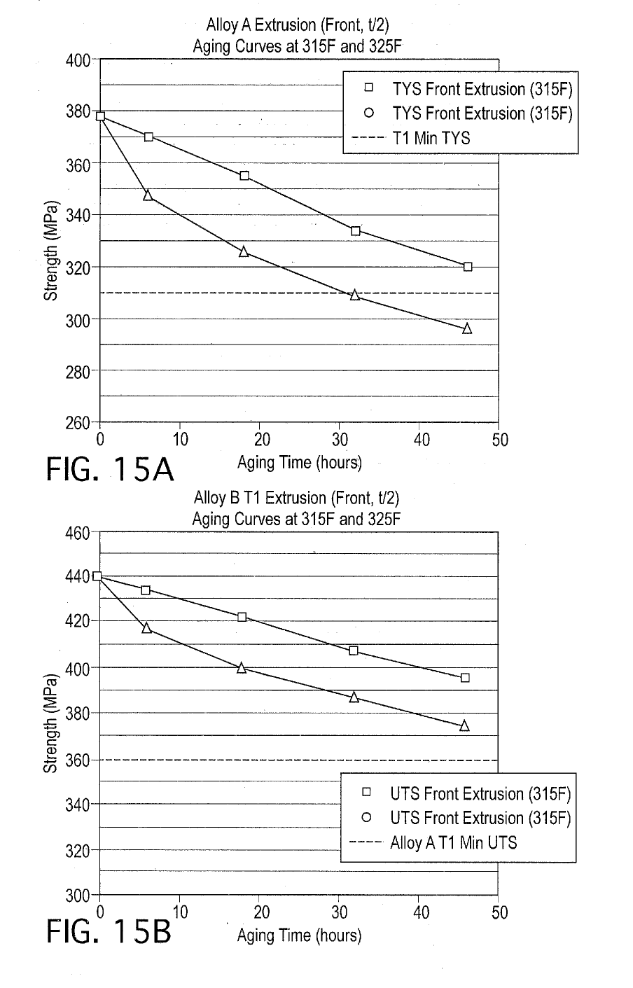

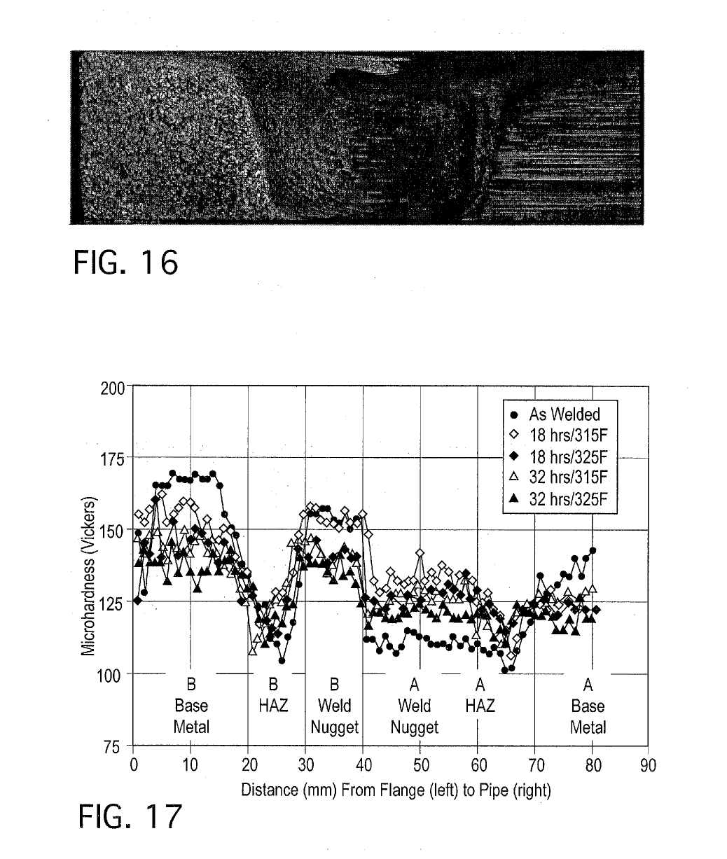

In addition, aging curves were generated in order to understand the effect of aging time on forging and extrusion parent metal. The aging curves were generated at 315 F (157 C) and 325 F (163 C). FIGS. 15A and 15B show the TYS and UTS aging curves of Alloy B forging shape A at the t/4 location. FIGS. 16A and 16B show the TYS and UTS aging curves for the Alloy A front extrusion. These aging curves can be used to assess the impact of additional aging practices.

In order to evaluate the tensile properties of the Alloy A-Alloy B FSW joints, one Alloy B Forging A coupling-to-Alloy A pipe and one Alloy B Forging B coupling-to-Alloy A pipe FSW joint were characterized. For the FSW with Forging B, a post-weld aging study was conducted at 315 F and 325 F with aging times ranging from 18 hours up to 44 hours using the “steady state” section of the of the FSW joint (i.e. the single pass region). In addition, the steady state of the joint with forging B was also tested with selected PWA conditions. Table 20 (Below) summarizes these tensile test results.

TABLE 20

| | Location | | | | | |
|---|---|---|---|---|---|---|
| | Steady State | | | Steady State | | |
| | 90-360 degrees | | | 90-360 degrees | | |
| | Description | | | | | |
| | Forging B to Extrusion | | | Forging A to Extrusion | | |
| | TYS | UTS | | TYS | UTS | |
| | (MPa) | (MPa) | % EI | (MPa) | (MPa) | % EI |
| As-Welded | 280 | 403 | 6.0 | | | |
| 6 hrs/250 F. + | 353 | 411 | 4.0 | 369 | 416 | 6.5 |
| 18 hrs/315 F. | | | | | | |
| 6 hrs/250 F. + | 345 | 384 | 2.5 | | | |
| 24 hrs/315 F. | | | | | | |
| 6 hrs/250 F. + | 336 | 384 | 3.6 | 345 | 392 | 3.8 |
| 32 hrs/315 F. | | | | | | |
| 6 hrs/250 F. + | 323 | 393 | 7.4 | | | |
| 18 hrs/325 F. | | | | | | |
| 6 hrs/250 F. + | 333 | 399 | 4.8 | 341 | 399 | 6.4 |
| 24 hrs/325 F. | | | | | | |
| 6 hrs/250 F. + | 323 | 395 | 6.3 | | | |
| 32 hrs/325 F. | | | | | | |
| 6 hrs/250 F. + | 310 | 385 | 9.5 | 313 | 378 | 5.0 |
| 44 hrs/325 F. | | | | | | |
| 6 hrs/250 F. + | 297 | 374 | 9.7 | | | |
| 18 hrd/315 F. | | | | | | |

*Note - Reported values are the average of two tests per location.

The 18 hours/325 F PWA practice resulted in a joint TYS of 333 MPa for the steady state section of Joint with forging B. For the same PWA condition, the TYS of the start and stop locations were 10-16 MPa lower than the steady-state region. The joint with forging A had a TYS of 341 MPa with the same PWA condition in the steady-state. It was also observed that increasing the aging time from 18 hours to 32 hours at 325 F resulted in a decrease of ˜25 MPa in TYS. The elongation values ranged from 3 to 6.5% (measured on a 102 mm gage length).

The corrosion behavior of the parent metal Alloy A extrusions, Alloy B forgings and the Alloy A-Alloy B FSW joints were evaluated by Stress Corrosion Cracking testing (ASTM G44 Alternate Immersion, ASTM G103 Boiling Salt Water), Type-of-Attack testing (ASTM G110) and also by generating corrosion potential profiles across the FSW joints.

SCC tests were conducted on the Alloy A parent metal in 6% NaCl boiling salt water solution according to the ASTM G103 standard. A range of possible PWA conditions were evaluated, as depicted in Table 21:

TABLE 21
PWA conditions for Alloy A Parent metal aging.

| | Step 1 | Step 2 |
|---|---|---|
| PWA-1 | 250 F./6 hrs | 315 F./18 hrs |
| PWA-2 | | 315 F./32 hrs |
| PWA-3 | | 320 F./18 hrs |
| PWA-4 | | 320 F./32 hrs |
| PWA-5 | | 330 F./18 hrs |
| PWA-6 | | 330 F./32 hrs |

The test specimens were taken in the longitudinal direction of the extruded pipe and stressed at 142 and 213 MPa. Three replicate specimens (21 mm gauge for each specimen) were stressed for each aging condition and the stress level. The pass/fail criterion for the Alloy A extrusions was 6 days, and there were no failures observed after 14 days of exposure, regardless of the aging condition. Table 22 summarizes the test results.

TABLE 22
ASTM G103 boiling saltwater test of Alloy A extrusion aged at 315 F.,
320 F. and 330 F.

| | | | | Days to Failure | | |
|---|---|---|---|---|---|---|
| | | Orien- | Stress | Specimen | Specimen | Specimen |
| S # | Description | tation | (MPa): | 1 | 2 | 3 |
| 1 | PWA-3 | L | 142 | OK | OK | OK |
| | | | 213 | OK | OK | OK |
| 2 | PWA-4 | L | 142 | OK | OK | OK |
| | | | 213 | OK | OK | OK |
| 3 | PWA-5 | L | 142 | OK | OK | OK |
| | | | 213 | OK | OK | OK |
| 4 | PWA-6 | L | 142 | OK | OK | OK |
| | | | 213 | OK | OK | OK |
| 5 | PWA-1 | L | 142 | OK | OK | OK |
| | | | 213 | OK | OK | OK |
| 6 | PWA-2 | L | 142 | OK | OK | OK |
| | | | 213 | OK | OK | OK |

Note:
All received in T7X temper, Aging refers to further aging.

Stress Corrosion Cracking (SCC) Testing of Alloy B Parent Metal was conducted by Alternate Immersion testing in a 3.5% NaCl solution according to ASTM G44. A wide range of PWA conditions, which were identical to the Alloy A parent metal SCC testing, were evaluated for the Alloy B-T652 forgings. The forgings were sampled in ST, L & LT directions and stressed at 160 and 240 MPa. Three replicate specimens were stressed for each aging condition and stress level. The pass/fail criterion for the Alloy B forgings was 60 days and there were no failures after 60 days exposure regardless of the aging condition. Table 23 depicts the test results of specimens after 132 days in test (T means “still in test” i.e. no measured failure yet) and Table 24 depicts the test results of specimens after 118 days in test.

TABLE 23
ASTM G44 Alternate Immersion test of Alloy B forgings aged at 320 F. and 330 F.

| | | Gauge | | | Stress | Days to Failure | | |
|---|---|---|---|---|---|---|---|---|
| S # | Shape | (mm) | PWA | Orientation | (MPa): | Specimen 1 | Specimen 2 | Specimen 3 |
| 1 | Forging A | 127 | PWA-3 | ST | 160 | OK | OK | OK |
| | | | | | 240 | OK | OK | OK |
| 2 | Forging A | 127 | PWA-4 | ST | 160 | OK | OK | OK |
| | | | | | 240 | OK | OK | OK |
| 3 | Forging A | 127 | PWA-5 | ST | 160 | OK | OK | OK |
| | | | | | 240 | OK | OK | OK |
| 4 | Forging A | 127 | PWA-6 | ST | 160 | OK | OK | OK |
| | | | | | 240 | OK | OK | OK |
| 5 | Forging B | 203 | PWA-3 | ST | 160 | OK | OK | OK |
| | | | | | 240 | OK | OK | 90 |
| 6 | Forging B | 203 | PWA-4 | ST | 160 | OK | OK | OK |
| | | | | | 240 | OK | OK | OK |
| 7 | Forging B | 203 | PWA-5 | ST | 160 | OK | OK | OK |
| | | | | | 240 | OK | OK | 129 |
| 8 | Forging B | 203 | PWA-6 | ST | 160 | OK | OK | OK |
| | | | | | 240 | OK | OK | OK |
| 9 | Forging B | 203 | PWA-3 | LT | 160 | OK | OK | OK |
| | | | | | 240 | OK | OK | OK |
| 10 | Forging B | 203 | PWA-4 | LT | 160 | OK | OK | OK |
| | | | | | 240 | OK | OK | OK |
| 11 | Forging B | 203 | PWA-5 | LT | 160 | OK | OK | OK |
| | | | | | 240 | OK | OK | OK |
| 12 | Forging B | 203 | PWA-6 | LT | 160 | OK | OK | OK |
| | | | | | 240 | OK | OK | OK |
| 13 | Forging B | 203 | PWA-3 | L | 160 | OK | OK | OK |
| | | | | | 240 | OK | OK | OK |
| 14 | Forging B | 203 | PWA-4 | L | 160 | OK | OK | OK |
| | | | | | 240 | OK | OK | OK |
| 15 | Forging B | 203 | PWA-5 | L | 160 | OK | OK | OK |
| | | | | | 240 | OK | OK | OK |
| 16 | Forging B | 203 | PWA-6 | L | 160 | OK | OK | OK |
| | | | | | 240 | OK | OK | OK |

TABLE 24
ASTM G44 Alternate Immersion test of Alloy B forgings aged at 315 F.

| Alloy/ | Gauge | | | Stress | Days to Failure | | |
|---|---|---|---|---|---|---|---|
| Temper | (mm) | Description | Orientation | (MPa): | Specimen 1 | Specimen 2 | Specimen 3 |
| Forging A | 203 | PWA-1 | L | 160 | OK | OK | OK |
| | | | | 240 | OK | OK | OK |
| Forging A | 203 | PWA-2 | L | 160 | OK | OK | OK |
| | | | | 240 | OK | OK | OK |
| Forging A | 127 | PWA-1 | L | 160 | OK | OK | OK |
| | | | | 240 | OK | OK | OK |
| Forging A | 127 | PWA-2 | L | 160 | OK | OK | OK |
| | | | | 240 | OK | OK | OK |
| Forging B | 203 | PWA-1 | ST | 160 | OK | OK | OK |
| | | | | 240 | OK | OK | OK |
| Forging B | 203 | PWA-2 | ST | 160 | OK | OK | OK |
| | | | | 240 | OK | OK | OK |
| Forging B | 203 | PWA-1 | LT | 160 | OK | OK | OK |
| | | | | 240 | OK | OK | OK |
| Forging B | 203 | PWA-2 | LT | 160 | OK | OK | OK |
| | | | | 240 | OK | OK | OK |

Two failures were observed after extended periods of testing, at 90 and 129 days at 240 MPa. However, failures at such extended periods are not necessarily due to SCC susceptibility.

The weld zone was comprised of two distinct regions as shown in FIG. 6: the high-Cu weld zone and the low-Cu/Cu-free weld zone. To assess the SCC resistance of the Alloy A weld zone, ASTM G103 6% NaCl boiling salt water test was conducted using specimens that only contained the Alloy A alloy in the test section. The test specimens were taken in the longitudinal direction (i.e. transverse to the FSW joint) and stressed at 170 MPa. Alloy B cylinders (6.35 mm diameter by 38.10 mm long machined out of the Alloy B parent metal), were electrically connected to the SCC specimens during the boiling salt water testing. This was completed in order to simulate the electrical presence of the Alloy B parent material across the weld, without subjecting Alloy B parent material to the boiling salt test. Without being bound to any mechanism or theory, the connection of Alloy B parent material may simulate any possible galvanic interactions that may be present in the FSW joint (i.e. through the high-Cu material).

The following eight PWA conditions were evaluated: 18, 24, 32 and 44 hrs at 315 F and 325 F. Note that the aging practice of the Alloy B cylinders that were electrically attached to the test frame was the same as the PWA condition of the specimen that was being tested. The samples were 21 mm gauge. All specimens passed the 6 day test period when tested across the weld (ATW). (Table 23). There were two failures (out of 24 specimens) on the 7th day of the testing.

TABLE 25
ASTM G103 boiling salt-water test of Alloy B-Alloy A FSW joints across the weld aged
at 315 F. and 325 F.

| | | | Stress | Days to Failure | | |
|---|---|---|---|---|---|---|
| S # | Description | Orientation | (MPa): | Specimen 1 | Specimen 2 | Specimen 3 |
| 1 | Steady state (90-360 degrees) | ATW | 170 | OK | 7 | OK |
| | 6 h/250 .F + 18 h/315 .F | | | | | |
| 2 | Steady state (90-360 degrees) | ATW | 170 | OK | OK | OK |
| | 6 h/250 F. + 24 h/315 F. | | | | | |
| 3 | Steady state (90-360 degrees) | ATW | 170 | OK | 7 | OK |
| | 6 h/250 F. + 32 h/315 F. | | | | | |
| 4 | Steady state (90-360 degrees) | ATW | 170 | OK | OK | OK |
| | 6 h/250 F. + 44 h/315 F. | | | | | |
| 5 | Steady state (90-360 degrees) | ATW | 170 | OK | OK | OK |
| | 6 h/250 F. + 18 h/325 F. | | | | | |
| 6 | Steady state (90-360 degrees) | ATW | 170 | OK | OK | OK |
| | 6 h/250 F. + 24 h/325 F. | | | | | |
| 7 | Steady state (90-360 degrees) | ATW | 170 | OK | OK | OK |
| | 6 h/250 F. + 32 h/325 F. | | | | | |
| 8 | Steady state (90-360 degrees) | ATW | 170 | OK | OK | OK |
| | 6 h/250 F. + 44 h/325 F. | | | | | |

The high-Cu (Alloy B) side of the weld-zone was evaluated in ASTM G44 3.5% NaCl Alternate Immersion (AI) testing. The following eight PWA conditions were evaluated: 18, 24, 32 and 44 hrs at 315 F and 325 F. The test specimens were taken across the weld (i.e. transverse to the FSW joint) and stressed at 170 MPa and 255 MPa. The test spanned 84 days. The results are depicted in Table 26, below.

TABLE 26
ASTM G44 Alternate Immersion test of Alloy B-Alloy A FSW joints across the weld aged
at 315 F. and 325 F.

| | Gauge | | | Stress | Days to Failure | | |
|---|---|---|---|---|---|---|---|
| S# | (mm) | Description | Orientation | (MPa): | Specimen 1 | Specimen 2 | Specimen 3 |
| 1 | 21 | PWA 6 h/250 F. + | ATW | 170 MPa | OK | OK | OK |
| | | 18 h/325 F. | | 255 MPa | OK | OK | OK |
| 2 | 21 | PWA 6 h/250 F. + | ATW | 170 MPa | OK | OK | OK |
| | | 24 h/325 F. | | 255 MPa | OK | OK | OK |
| 3 | 21 | PWA 6 h/250 F. + | ATW | 170 MPa | OK | OK | OK |
| | | 32 h/325 F. | | 255 MPa | OK | OK | OK |
| 4 | 21 | PWA 6 h/250 F. + | ATW | 170 MPa | OK | OK | OK |
| | | 44 h/325 F. | | 255 MPa | OK | OK | OK |
| 5 | 21 | PWA 6 h/250 F. + | ATW | 170 MPa | OK | OK | OK |
| | | 18 h/315 F. | | 255 MPa | OK | OK | OK |
| 6 | 21 | PWA 6 h/250 F. + | ATW | 170 MPa | OK | OK | OK |
| | | 24 h/315 F. | | 255 MPa | OK | OK | OK |
| 7 | 21 | PWA 6 h/250 F. + | ATW | 170 MPa | OK | OK | OK |
| | | 32 h/315 F. | | 255 MPa | OK | OK | OK |
| 8 | 21 | PWA 6 h/250 F. + | ATW | 170 MPa | OK | OK | OK |
| | | 44 h/315 F. | | 255 MPa | OK | OK | OK |

No failures were observed after 84 days of exposure.

FIG. 17 depicts the microhardness measured across the FSW A-B sample, taken at different PWA practices.

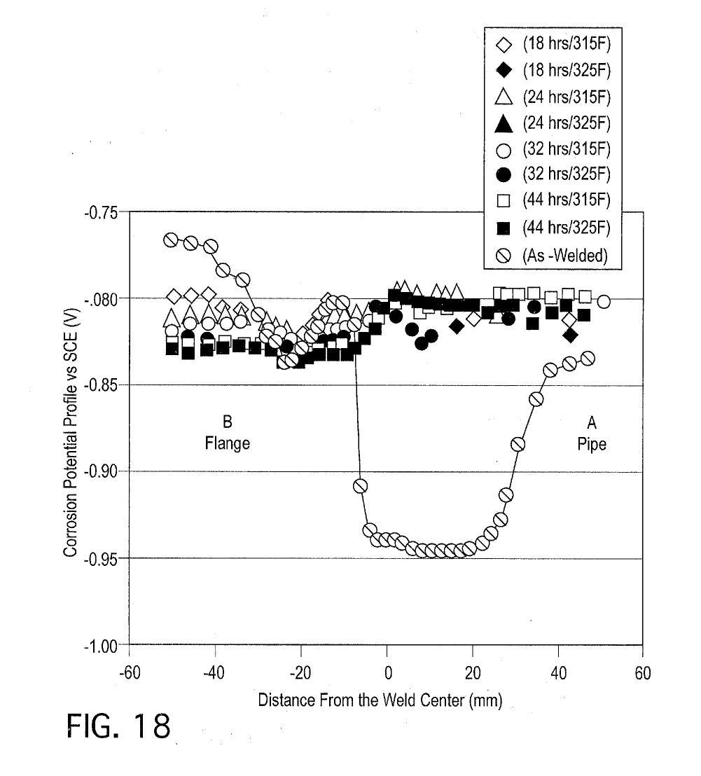

The corrosion potential profiles across the FSW joints (e.g. depicted in FIG. 16) were generated per ASTM G69 standard in order to understand the galvanic effects of various FSW zones in the as-welded and post-weld-aged conditions. FIG. 18 shows all profiles that were evaluated. In the as-welded condition, the weld zone appears to be significantly anodic with respect to both Alloy B and Alloy A parent metal. Though not being bound by any mechanism or theory, it is possible that preferential attack may occur in the weld zone due to the potential difference in the as-welded condition.

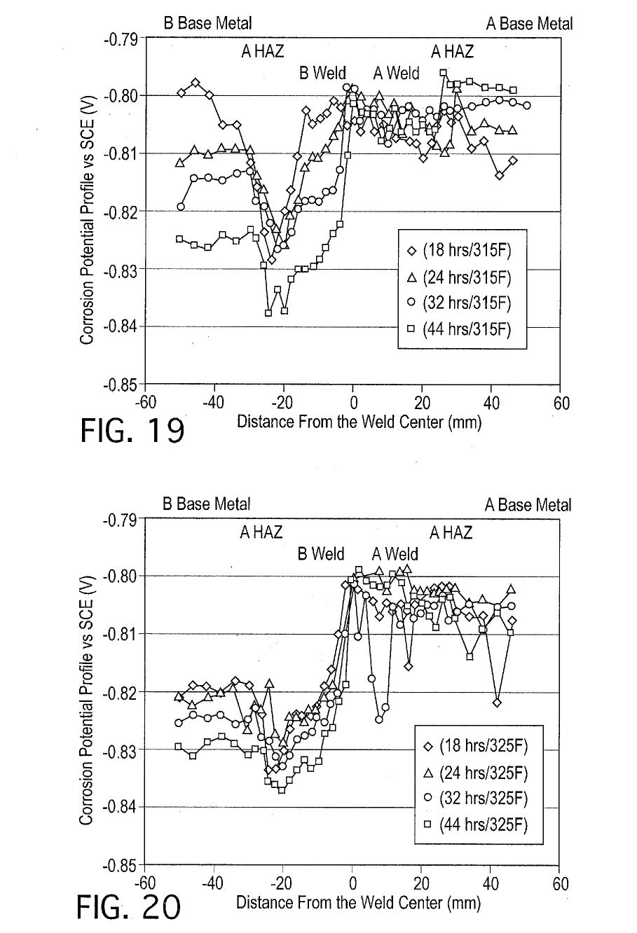

Upon post-weld-aging, the corrosion potential profile levels out to a significant degree, even with the least amount aging that was evaluated (i.e. 315 F for 18 hours). FIG. 19 shows a magnified section of the potential profile for aging times at 315 F. For example, when the aging time is 24 hours, Alloy B weld zone becomes slightly anodic (˜5-10 mV) to the Alloy A weld zone. Upon further aging to 32 hours and 44 hours, the spread between the Alloy B weld zone and Alloy A weld zone increases. FIG. 20 shows the potential profiles when the FSW joints are aged 325 F. FIG. 20 depicts that regardless of the aging time, the Alloy B parent metal is more anodic than the Alloy A weld zone when aged at 325 F.

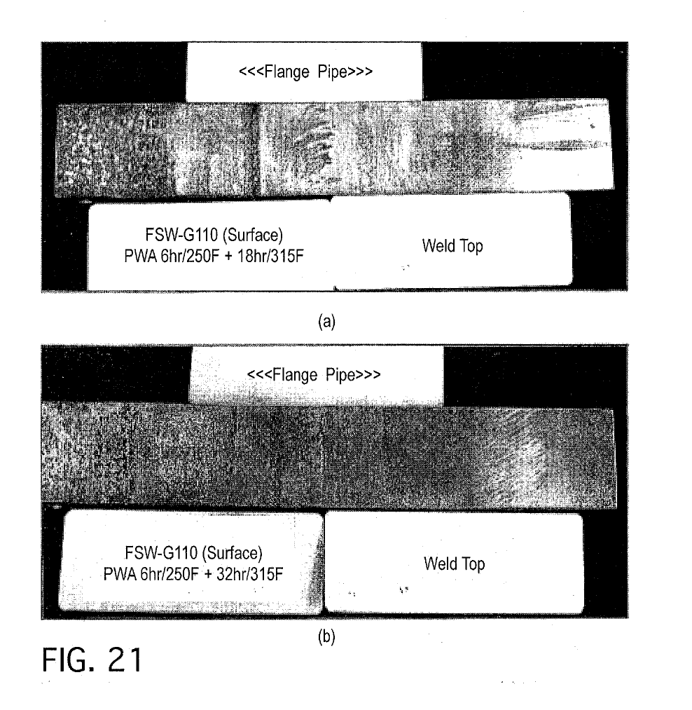

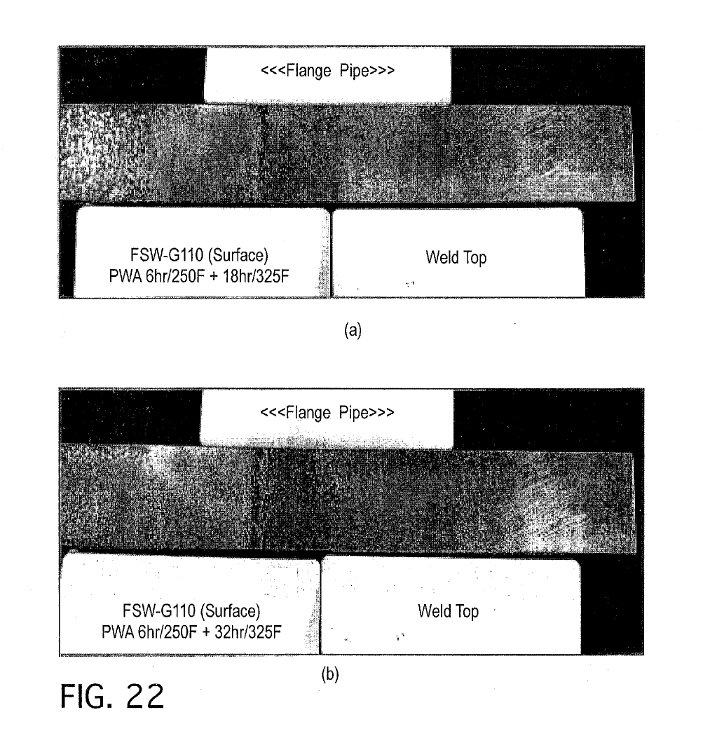

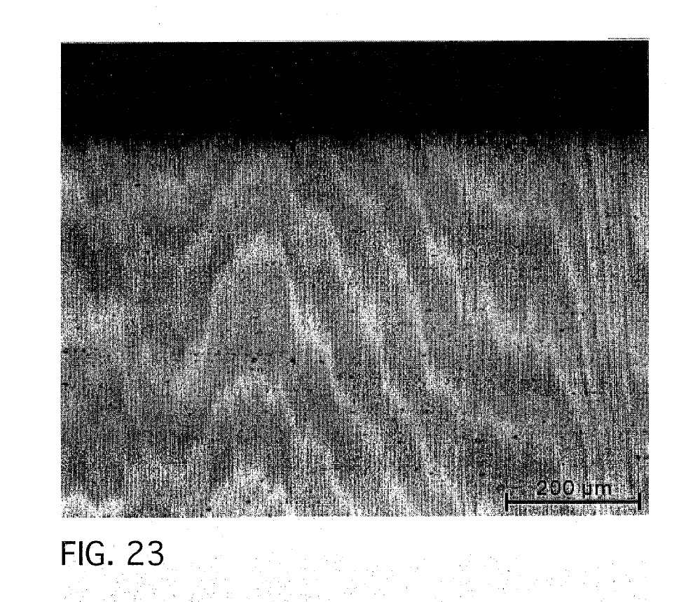

The Alloy A-Alloy B FSW joints and the adjacent parent metal were evaluated for the “Type-of-attack” testing according to ASTM G110 standard. Alloy A-Alloy B FSW joints evaluated in this part of the program were aged at 315 F and 325 F for 18 hours and 32 hours. The photographs of the as-exposed specimens are shown in FIG. 21 and FIG. 22 for aging temperatures of 315 F and 325 F, respectively. The exposure time in the G110 solution was 6 hours. There was no appreciable corrosion on the Alloy A side of the joint. This behavior is consistent with the corrosion potential profiles. Pitting was observed on the Alloy B side of the FSW joints, with pitting near the Alloy B heat affected zone (HAZ). As shown in the corrosion potential profile of FIG. 18, the most anodic region of the FSW is the Alloy B HAZ. FIG. 23 shows the typical cross section of Alloy A after the G110 Type-of-Attack testing. FIG. 23 exhibits, as observed, there was no pitting or intergranular corrosion attack was observed for this low copper (Cu free) alloy. The aging practice for the specimen shown in FIG. 23 is 250 F for 6 hours+315 F for 18 hours.

While various embodiments of the present disclosure have been described in detail, it is apparent that modifications and adaptations of those embodiments will occur to those skilled in the art. However, it is to be expressly understood that such modifications and adaptations are within the spirit and scope of the present disclosure.

TABLE 27
Compositional Limits of certain AA 7XXX alloys. (Note: Balance is Al)

| AA | | | | | | | | | | | Others/ | Others/ |
|---|---|---|---|---|---|---|---|---|---|---|---|---|
| Alloy # | Si | Fe | Cu | Mn | Mg | Cr | Ni | Zn | Ti | Zr | Each | Total |
| AA7003 | 0.30 | 0.35 | 0.20 | 0.30 | 0.50-1.0 | 0.20 | | 5.0-6.5 | 0.20 | 0.05-0.25 | 0.05 | 0.15 |
| AA7004 | 0.25 | 0.35 | 0.05 | 0.20-0.7 | 1.0-2.0 | 0.05 | | 3.8-4.6 | 0.05 | 0.10-0.20 | 0.05 | 0.15 |
| AA7005 | 0.35 | 0.40 | 0.10 | 0.20-0.7 | 1.0-1.8 | 0.06-0.20 | | 4.0-5.0 | 0.01-0.06 | 0.08-0.20 | 0.05 | 0.15 |
| AA7017 | 0.35 | 0.45 | 0.20 | 0.05-0.50 | 2.0-3.0 | 0.35 | 0.10 | 4.0-5.2 | 0.15 | 0.10-0.25 | 0.05 | 0.15 |
| AA7018 | 0.35 | 0.45 | 0.20 | 0.15-0.50 | 0.7-1.5 | 0.20 | 0.10 | 4.5-5.5 | 0.15 | 0.10-0.25 | 0.05 | 0.15 |
| AA7019 | 0.35 | 0.45 | 0.20 | 0.15-0.50 | 1.5-2.5 | 0.20 | 0.10 | 3.5-4.5 | 0.15 | 0.10-0.25 | 0.05 | 0.15 |
| AA7022 | 0.50 | 0.50 | 0.50-1.0 | 0.10-0.40 | 2.6-3.7 | 0.10-0.30 | | 4.3-5.2 | | | | 0.15 |
| AA7049 | 0.25 | 0.35 | 1.2-1.9 | 0.20 | 2.0-2.9 | 0.10-0.22 | | 7.2-8.2 | 0.10 | | 0.05 | 0.15 |
| AA7150 | 0.12 | 0.15 | 1.9-2.5 | 0.10 | 2.0-2.7 | 0.04 | | 5.9-6.9 | 0.06 | 0.08-0.15 | 0.05 | 0.15 |
| AA7075 | 0.40 | 0.50 | 1.2-2.0 | 0.30 | 2.1-2.9 | 0.18-0.28 | | 5.1-6.1 | 0.20 | | 0.05 | 0.15 |
| AA7085 | 0.06 | 0.08 | 1.3-2.0 | 0.04 | 1.2-1.8 | 0.04 | | 7.0-8.0 | 0.06 | 0.08-0.15 | 0.05 | 0.15 |

What is claimed is:

1. An assembly, comprising:
a first 7xxx series aluminum alloy member comprising not greater than 1 wt. % Cu;
a second 7xxx series aluminum alloy member comprising at least 1 wt % Cu;
a joint between the first member and the second member that joins the first member to the second member;
wherein the assembly exhibits a stress corrosion cracking resistance for a marine environment.

2. The assembly of claim 1, wherein the first member passes stress corrosion cracking resistance tests at a stress level of 213 MPa as measured in accordance with the boiling salt test, ASTM standard G-103, in the L direction for a period of at least 7 days.

3. The assembly of claim 1, wherein the first member shows no pitting corrosion or intergranular corrosion in accordance with the type of attack test, ASTM G-110.

4. The aluminum assembly of claim 1, wherein the second member passes stress corrosion cracking resistance tests at a stress level of 240 MPa, as measured in accordance with the alternate immersion test, ASTM standards G-44, in the ST direction for a period of at least 30 days.

5. The assembly of claim 1, wherein the second member of the assembly comprises a corrosion potential that is at least 5 mV less than the low copper zone of the joint.

6. The assembly of claim 1, wherein the second member comprises an overaged temper.

7. The assembly of claim 1, wherein the joint is a solid state weld.

8. The assembly of claim 1, wherein the joint comprises a mechanical connection.

9. The assembly of claim 1, wherein the joint comprises a tensile yield strength of at least about 297 MPa as measured across the joint.

10. An assembly, comprising:
a first member comprising a 7xxx series aluminum alloy having not greater than 1 wt. % Cu;
a second member comprising a 7xxx series aluminum alloy member having at least 1 wt % Cu wherein the second member comprises an overaged condition; and
a weld attaching the first member and the second member, wherein the weld includes a low Cu zone;
wherein the low Cu zone of the weld exhibits a stress corrosion cracking resistance in a marine environment due to the overaged condition.

11. The weld assembly of claim 10, wherein the overaged condition comprises a T7 temper.

12. The weld assembly of claim 10, wherein the low Cu zone of the weld comprises a corrosion potential of at least 5 mV above a corrosion potential of the second member, as measured in accordance with ASTM G-69.

13. The weld assembly of claim 10, wherein the stress corrosion cracking resistance in the marine environment comprises:
the low Cu zone of the weld passes stress corrosion cracking resistance tests at a stress level of 170 MPa as measured in accordance with the boiling salt test, ASTM standard G-103 across the weld for a period of at least 6 days.

14. The assembly of claim 10, wherein the first member and the second member are selected from the group consisting of: an extrusion; a forging, a sheet; and a plate; and combinations thereof.

15. A method comprising:
(a) welding a first member comprising:
a 7xxx series aluminum alloy having not less than 1 wt. % Cu to
a second member comprising a 7xxx series aluminum alloy member having not greater than 1 wt. % Cu,
thereby producing an assembly having a weld, the weld including a low Cu zone and a high Cu zone;
(b) thermally treating the assembly at a sufficient time and temperature such that the second member comprises an averaged temper;
wherein due to the thermally treating step, the low Cu zone of the weld comprises an improved corrosion cracking resistance in a marine environment.

16. The method of claim 15, wherein the thermally treating step comprises aging the second member to a T7 temper.

17. The method of claim 15, wherein, due to the thermally treating step, the second member comprises a corrosion potential difference at least about 5 mV lower than the low Cu zone of the weld.

18. The method of claim 15, wherein the welding comprises solid state welding.

19. The method of claim 15, wherein welding comprises friction stir welding.

20. The method of claim 15, further comprising increasing at least one of the time or temperature of the thermally treating step to increase the corrosion potential difference between the low Cu weld zone and the second member.
